(19) United States
(12) Patent Application Publication
(10) Pub. No.: US 2019/0252800 A1
(43) Pub. Date: Aug. 15, 2019

(54) SELF-MULTIPLEXING ANTENNAS

(71) Applicant: Space Exploration Technologies Corp., Hawthorne, CA (US)

(72) Inventors: Ersin Yetisir, Redmond, WA (US); Alireza Mahanfar, Redmond, WA (US)

(73) Assignee: Space Exploration Technologies Corp., Hawthorne, CA (US)

(21) Appl. No.: 16/276,317

(22) Filed: Feb. 14, 2019

Related U.S. Application Data
(60) Provisional application No. 62/631,685, filed on Feb. 17, 2018.
(60) Provisional application No. 62/631,195, filed on Feb. 15, 2018.

(51) Int. Cl. H01Q 21/22; H01Q 21/06; H01Q 19/10; H01Q 1/52; H01Q 1/38

(52) U.S. Cl. CPC H01Q 21/22; H01Q 21/065; H01Q 19/10; H01Q 5/50; H01Q 1/526; H01Q 1/38; H01Q 1/521

(57) ABSTRACT

In one embodiment of the present disclosure, a self-multiplexing antenna includes a substrate, a first antenna element carried by the substrate, the first antenna element including a first antenna patch, and a first antenna reflector, a first signal feed connected with the first antenna patch, a second antenna element carried by the substrate, wherein the second antenna element is at least partially vertically aligned with the first antenna element, the second antenna element including a second antenna patch, and a second antenna reflector, a second signal feed connected with the second antenna patch, and a first isolator cavity between the second antenna reflector and the first antenna patch.

### CROSS-REFERENCES TO RELATED APPLICATIONS

This application claims the benefit of U.S. Provisional Application Nos. 62/631,195, filed Feb. 15, 2018, and 62/631,685, filed Feb. 17, 2018, the disclosures of which are hereby incorporated by reference herein in their entirety.

### BACKGROUND

An antenna (such as a dipole antenna) typically generates radiation in a pattern that has a preferred direction. For example, the generated radiation pattern is stronger in some directions and weaker in other directions. Likewise, when receiving electromagnetic signals, the antenna has the same preferred direction. Signal quality (e.g., signal to noise ratio or SNR), whether in transmitting or receiving scenarios, can be improved by aligning the preferred direction of the antenna with a direction of the target or source of the signal. However, it is often impractical to physically reorient the antenna with respect to the target or source of the signal. Additionally, the exact location of the source/target may not be known. To overcome some of the above shortcomings of the antenna, a phased array antenna can be formed from a set of antenna elements to simulate a large directional antenna. An advantage of a phased array antenna is its ability to transmit and/or receive signals in a preferred direction (e.g., the antenna's beamforming ability) without physical repositioning or reorientating.

It would be advantageous to configure phased array antennas having increased bandwidth while maintaining a high ratio of the main lobe power to the side lobe power. Likewise, it would be advantageous to configure phased array antennas having reduced weight, reduced size, lower manufacturing cost, and/or lower power requirements. Accordingly, embodiments of the present disclosure are directed to these and other improvements in phase array antennas or portions thereof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a self-multiplexing antenna is provided. The self-multiplexing antenna includes: a substrate; a first antenna element carried by the substrate, the first antenna element including a first antenna patch, and a first antenna reflector; a first signal feed connected with the first antenna patch; a second antenna element carried by the substrate, wherein the second antenna element is stacked with the first antenna element, the second antenna element including a second antenna patch, and a second antenna reflector; a second signal feed connected with the second antenna patch; and a first isolator cavity between the second antenna reflector and the first antenna patch.

In accordance with another embodiment of the present disclosure, a self-multiplexing antenna is provided. The self-multiplexing antenna includes: a substrate; a first antenna element carried by the substrate, the first antenna including a first antenna patch, and a first antenna reflector; a first signal feed connected with the first antenna patch; a second antenna element carried by the substrate, wherein the second antenna is stacked with the first antenna element, the second antenna element including a second antenna patch, and a second antenna reflector; a second signal feed connected with the second antenna patch; a first isolator cavity between the first antenna reflector and the second antenna patch, wherein the first isolator cavity is dimensioned to suppress coupling of RF radiation between the first antenna element and the second antenna element at the second frequency; and a notch filter connected to the first signal feed of the first antenna and disposed in the first isolator cavity, the notch filter line having a length sized to filter out the first frequency.

In accordance with another embodiment of the present disclosure, a phased array antenna is provided. The phased array antenna includes: a carrier; and a plurality of self-multiplexing antenna element stacks, each stack including a first antenna element configured to transmit and/or receive signals at a first value of a parameter, a second antenna element configured to transmit and/or receive signals at a second value of a parameter, and an isolator cavity between the first and second antenna elements.

In accordance with another embodiment of the present disclosure, a self-multiplexing antenna is provided. The phased array antenna includes: a substrate; a first antenna element carried by the substrate; a second antenna element carried by the substrate; and an isolator cavity disposed between the first antenna element and the second antenna element.

In any of the embodiments described herein, the first antenna element may be configured to operate at a first frequency, and the second antenna element may be configured to operate at a second frequency different from the first frequency.

In any of the embodiments described herein, the second frequency may be greater than the first frequency.

In any of the embodiments described herein, the fractional guard-band (edge-to-edge) may be selected from the group consisting of greater than 4.5%, greater than 5%, greater, than 6%, and greater than 7%.

In any of the embodiments described herein, the first signal feed is a center conductor of a first coaxial line, wherein the first coaxial line may include a first shielding connected to the first antenna reflector, wherein the second signal feed is a center conductor of a second coaxial line, and wherein the second coaxial line may include a second shielding connected to the second antenna reflector.

In any of the embodiments described herein, the first shielding and the second shielding may include a plurality of metal vias in the substrate.

In any of the embodiments described herein, the second signal feed may be substantially centrally located with respect to the first antenna patch.

In any of the embodiments described herein, the self-multiplexing antenna may further include a third antenna element carried by the substrate, wherein the third antenna is at least partially vertically aligned with the first and second antenna elements, the third antenna element including a third antenna patch, and a third antenna reflector; a third signal feed connected with the third antenna patch; and a second isolator cavity between the second antenna patch and the third antenna reflector.

In any of the embodiments described herein, the substrate may be a printed circuit board (PCB) or a ceramic board.

In any of the embodiments described herein, the first isolator cavity may be dimensioned to suppress coupling of RF radiation between the first antenna element and the second antenna element at the second frequency.

In any of the embodiments described herein, the second antenna element may further include one or more parasitic elements configured to operate at the second frequency.

In any of the embodiments described herein, the one or more parasitic elements may be one or more resonator patches.

In any of the embodiments described herein, the parasitic elements may have the same shape as the second antenna patch.

In any of the embodiments described herein, the self-multiplexing antenna further may include a notch filter connected to the second signal feed of the second antenna and disposed in the first isolator cavity, the notch filter line having a length sized to filter out the first frequency.

In any of the embodiments described herein, the notch filter may be a trace line.

In any of the embodiments described herein, the first trace line may be wound in the first isolator cavity.

In any of the embodiments described herein, the self-multiplexing antenna further may include a tuning stub connected to the notch filter.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A illustrates a schematic of an electrical configuration for a phased array antenna system in accordance with one embodiment of the present disclosure including an antenna lattice defining an antenna aperture, mapping, a beamformer lattice, a multiplex feed network, a distributor or combiner, and a modulator or demodulator.

FIG. 1B illustrates a signal radiation pattern achieved by a phased array antenna aperture in accordance with one embodiment of the present disclosure.

FIG. 1C illustrates schematic layouts of individual antenna elements of phased array antennas to define various antenna apertures in accordance with embodiments of the present disclosure (e.g., rectangular, circular, space tapered).

FIG. 1D illustrates individual antenna elements in a space tapered configuration to define an antenna aperture in accordance with embodiments of the present disclosure.

FIG. 1E is a cross-sectional view of a panel defining the antenna aperture in FIG. 1D.

FIG. 1F is a graph of a main lobe and undesirable side lobes of an antenna signal.

FIG. 1G illustrates an isometric view of a plurality of stack-up layers which make up a phased array antenna system in accordance with one embodiment of the present disclosure.

FIG. 2A illustrates a schematic of an electrical configuration for multiple antenna elements in an antenna lattice coupled to a single beamformer in a beamformer lattice in accordance with one embodiment of the present disclosure.

FIG. 2B illustrates a schematic cross section of a plurality of stack-up layers which make up a phased array antenna system in an exemplary receiving system in accordance with the electrical configuration of FIG. 2A.

FIG. 3A illustrates a schematic of an electrical configuration for multiple interspersed antenna elements in an antenna lattice coupled to a single beamformer in a beamformer lattice in accordance with one embodiment of the present disclosure.

FIG. 3B illustrates a schematic cross section of a plurality of stack-up layers which make up a phased array antenna system in an exemplary transmitting and interspersed system in accordance with the electrical configuration of FIG. 3A.

FIG. 4 is a cross-sectional view of an individual antenna element in accordance with conventional technology.

FIG. 5A is a cross-sectional view of a stack of antenna elements in accordance with conventional technology.

FIG. 5B is an isometric view of a stack of antenna elements in accordance with conventional technology.

FIG. 6A is a cross-sectional view of a stack of antenna elements including an isolator cavity in accordance with one embodiment of the present disclosure.

FIG. 6B is a graph of scattering parameters of a stack of the antenna elements shown in FIG. 6A.

FIG. 7 is a sample graph of an electrical field associated with a stack of antenna elements in accordance with one embodiment of the present disclosure.

FIG. 8 is a cross-sectional view of a stack of antenna elements including a plurality of parasitic patches in accordance with one embodiment of the present disclosure.

FIGS. 9A and 9B are simulation results of RF signals of a stack of antenna elements in accordance with one embodiment of the present disclosure.

FIG. 10A is a schematic view of a filtering scheme for a stack of antenna elements in accordance with one embodiment of the present disclosure.

FIG. 10B is a graph of scattering parameters of a stack of the antenna elements shown in FIG. 10A.

FIGS. 11A and 11B are schematic views of a stack of antenna element including a notch filtering scheme in accordance with another embodiment of the present disclosure.

FIGS. 12A, 12B, and 12C are views of a stack of the antenna elements in accordance with another embodiment of the present disclosure.

### DETAILED DESCRIPTION

Embodiments of the present disclosure are directed to apparatuses and methods relating to self-multiplexing antennas and self-multiplexing antennas in phased array antenna systems. In one embodiment of the present disclosure, a self-multiplexing antenna includes a substrate, first and second antenna elements carried by the substrate, and an isolator cavity disposed between the first antenna element and the second antenna element. These and other aspects of the present disclosure will be more fully described below.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “top”, “bottom”, “top surface”, “bottom surface”, “vertical”, “horizontal”, and “lateral” in the present disclosure is meant to provide orientation for the reader with reference to the drawings and is not intended to be the required orientation of the components or to impart orientation limitations into the claims.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

Many embodiments of the technology described herein may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

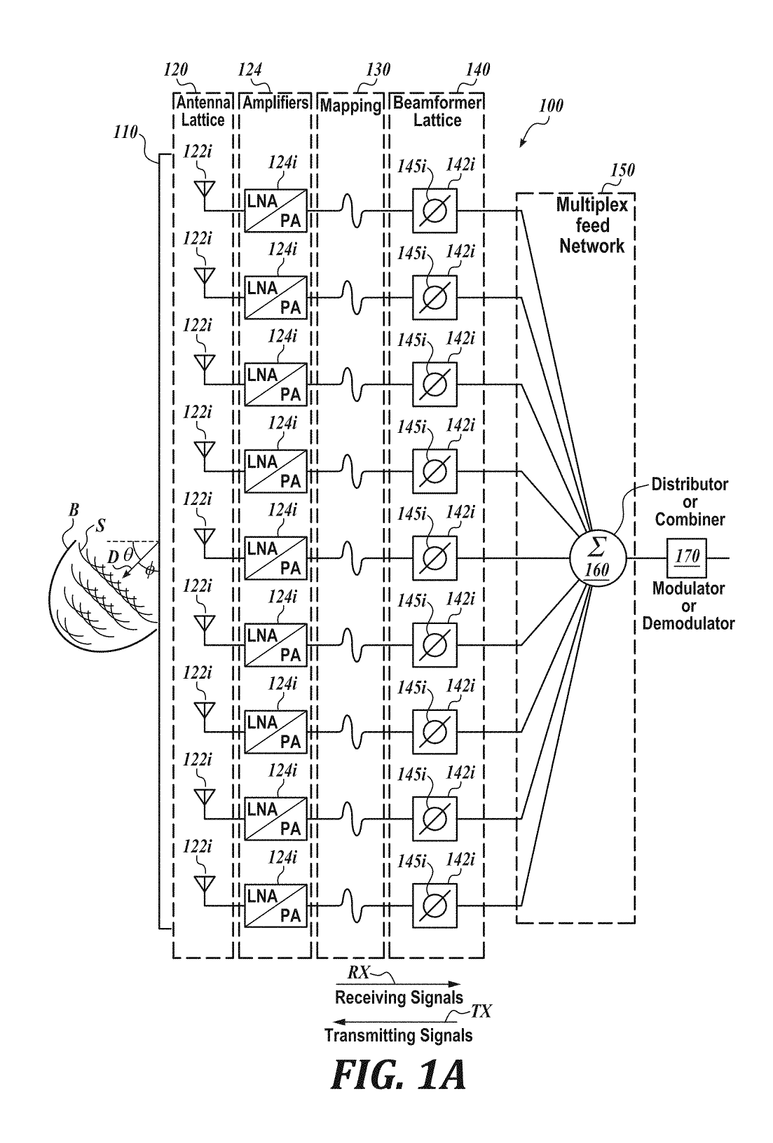

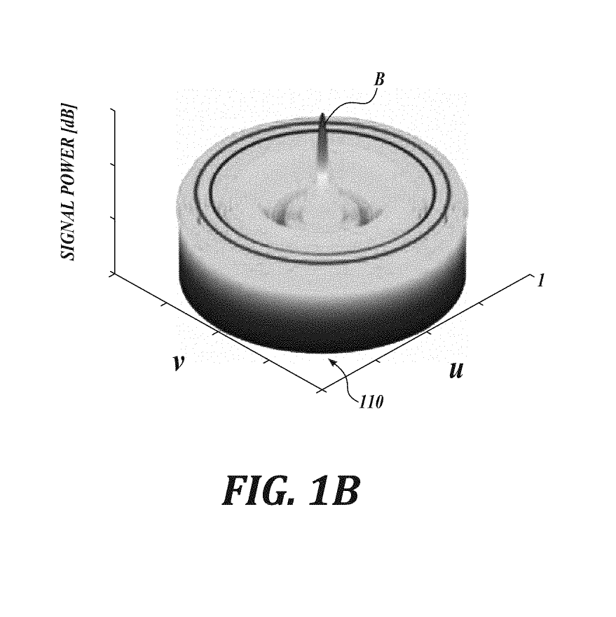

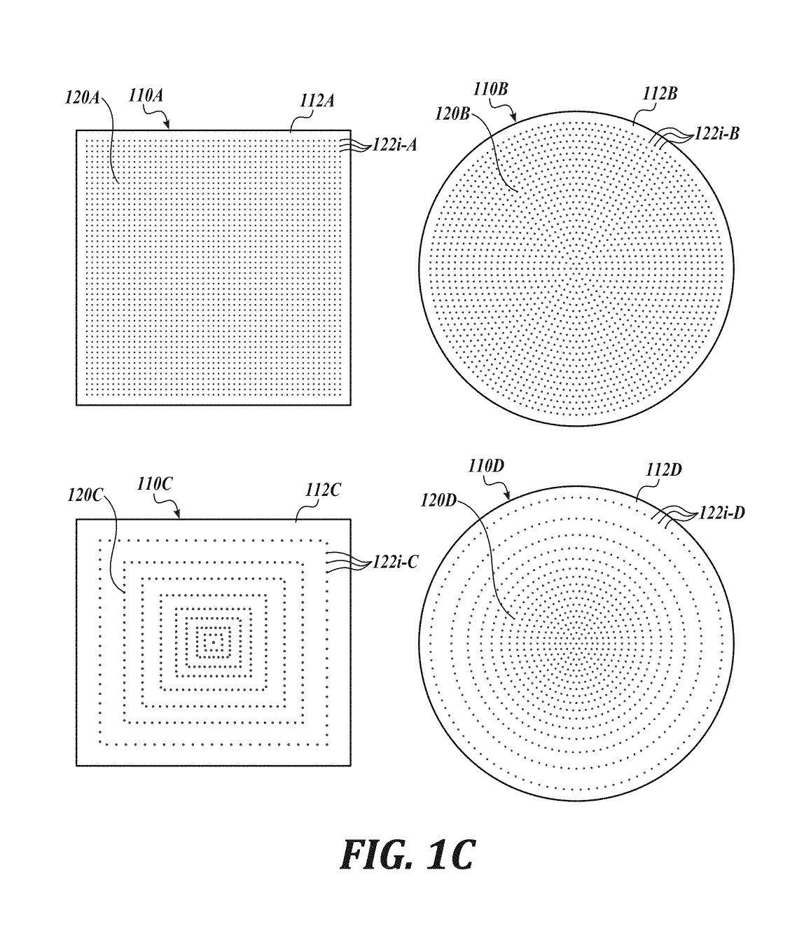

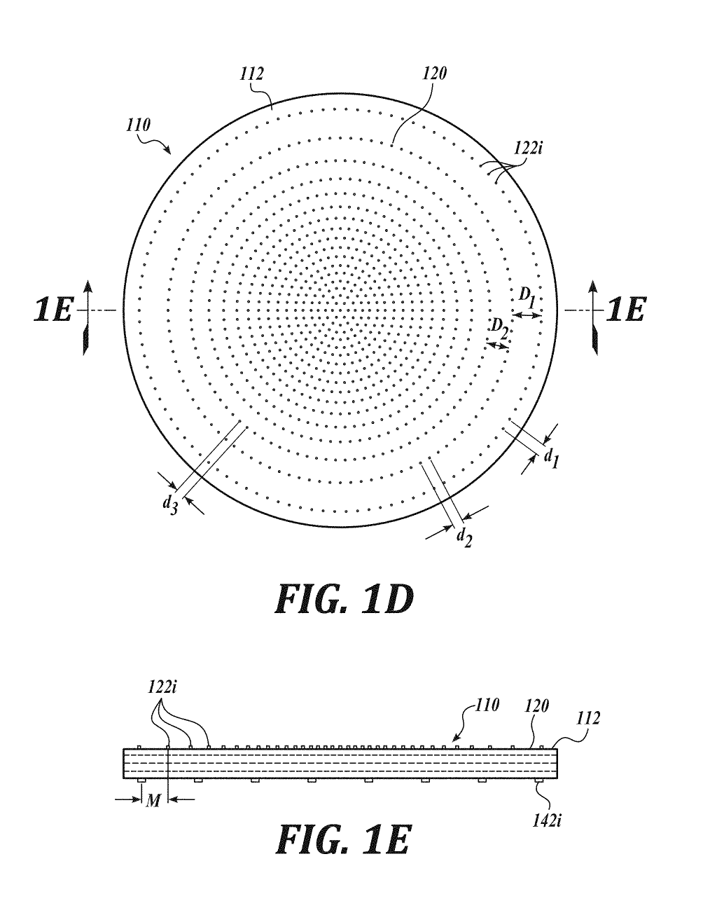

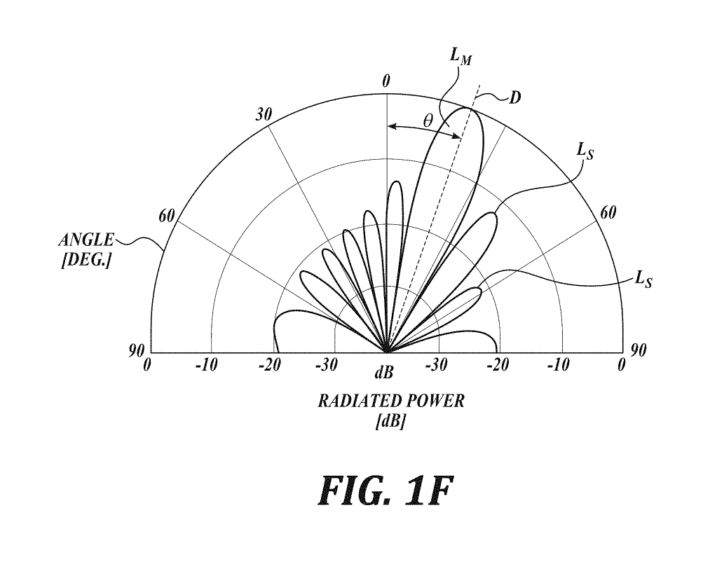

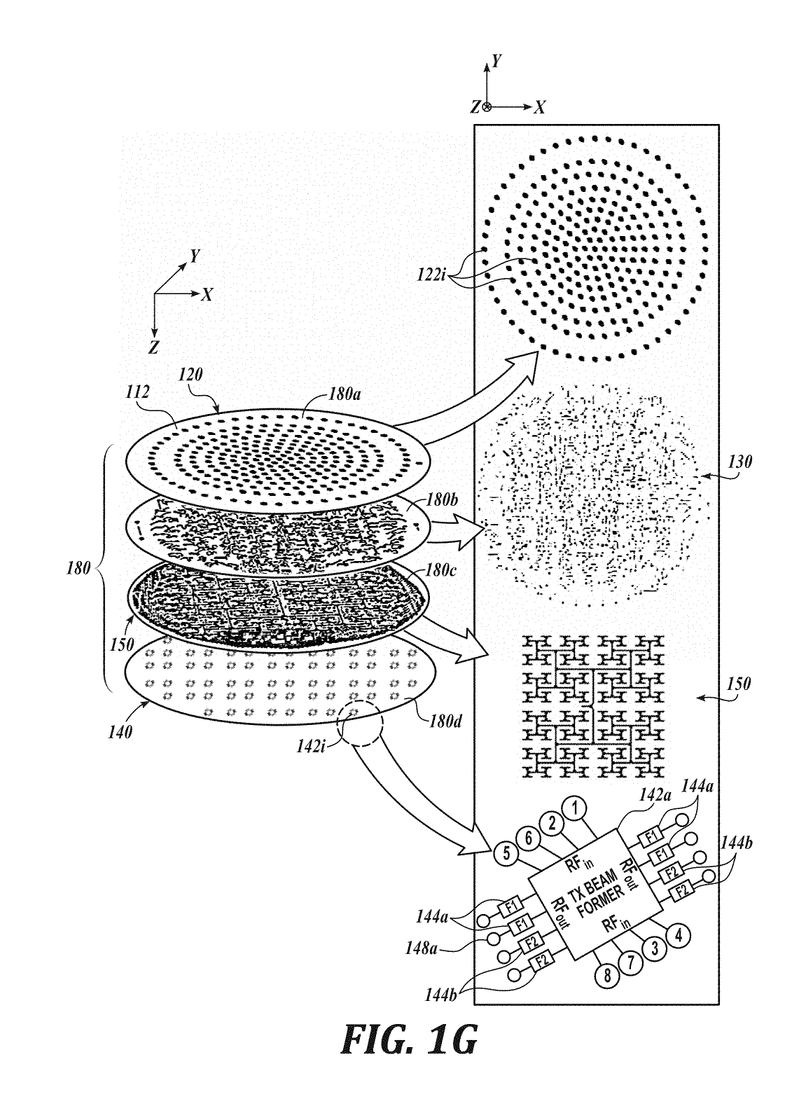

FIG. 1A is a schematic illustration of a phased array antenna system 100 in accordance with embodiments of the present disclosure. The phased array antenna system 100 is designed and configured to transmit or receive a combined beam B composed of signals S (also referred to as electromagnetic signals, wavefronts, or the like) in a preferred direction D from or to an antenna aperture 110. (Also see the combined beam B and antenna aperture 110 in FIG. 1B). The direction D of the beam B may be normal to the antenna aperture 110 or at an angle θ from normal.

Referring to FIG. 1A, the illustrated phased array antenna system 100 includes an antenna lattice 120, a mapping system 130, a beamformer lattice 140, a multiplex feed network 150 (or a hierarchical network or an H-network), a combiner or distributor 160 (a combiner for receiving signals or a distributor for transmitting signals), and a modulator or demodulator 170. The antenna lattice 120 is configured to transmit or receive a combined beam B of radio frequency signals S having a radiation pattern from or to the antenna aperture 110.

In accordance with embodiments of the present disclosure, the phased array antenna system 100 may be a multi-beam phased array antenna system, in which each beam of the multiple beams may be configured to be at different angles, different frequency, and/or different polarization.

In the illustrated embodiment, the antenna lattice 120 includes a plurality of antenna elements 122i. A corresponding plurality of amplifiers 124i are coupled to the plurality of antenna elements 122i. The amplifiers 124i may be low noise amplifiers (LNAs) in the receiving direction RX or power amplifiers (PAs) in the transmitting direction TX. The plurality of amplifiers 124i may be combined with the plurality of antenna elements 122i in for example, an antenna module or antenna package. In some embodiments, the plurality of amplifiers 124i may be located in another lattice separate from the antenna lattice 120.

Multiple antenna elements 122i in the antenna lattice 120 are configured for transmitting signals (see the direction of arrow TX in FIG. 1A for transmitting signals) or for receiving signals (see the direction of arrow RX in FIG. 1A for receiving signals). Referring to FIG. 1B, the antenna aperture 110 of the phased array antenna system 100 is the area through which the power is radiated or received. In accordance with one embodiment of the present disclosure, an exemplary phased array antenna radiation pattern from a phased array antenna system 100 in the u/v plane is provided in FIG. 1B. The antenna aperture has desired pointing angle D and an optimized beam B, for example, reduced side lobes Ls to optimize the power budget available to the main lobe Lm or to meet regulatory criteria for interference, as per regulations issued from organizations such as the Federal Communications Commission (FCC) or the International Telecommunication Union (ITU). (See FIG. 1F for a description of side lobes Ls and the main lobe Lm.)

Referring to FIG. 1C, in some embodiments (see embodiments 120A, 120B, 120C, 120D), the antenna lattice 120 defining the antenna aperture 110 may include the plurality of antenna elements 122i arranged in a particular configuration on a printed circuit board (PCB), ceramic, plastic, glass, or other suitable substrate, base, carrier, panel, or the like (described herein as a carrier 112). The plurality of antenna elements 122i, for example, may be arranged in concentric circles, in a circular arrangement, in columns and rows in a rectilinear arrangement, in a radial arrangement, in equal or uniform spacing between each other, in non-uniform spacing between each other, or in any other arrangement. Various example arrangements of the plurality of antenna elements 122i in antenna lattices 120 defining antenna apertures (110A, 110B, 110C, and 110D) are shown, without limitation, on respective carriers 112A, 112B, 112C, and 112D in FIG. 1C.

The beamformer lattice 140 includes a plurality of beamformers 142i including a plurality of phase shifters 145i. In the receiving direction RX, the beamformer function is to delay the signals arriving from each antenna element so the signals all arrive to the combining network at the same time. In the transmitting direction TX, the beamformer function is to delay the signal sent to each antenna element such that all signals arrive at the target location at the same time. This delay can be accomplished by using “true time delay” or a phase shift at a specific frequency.

Following the transmitting direction of arrow TX in the schematic illustration of FIG. 1A, in a transmitting phased array antenna system 100, the outgoing radio frequency (RF) signals are routed from the modulator 170 via the distributer 160 to a plurality of individual phase shifters 145i in the beamformer lattice 140. The RF signals are phase-offset by the phase shifters 145i by different phases, which vary by a predetermined amount from one phase shifter to another. Each frequency needs to be phased by a specific amount in order to maintain the beam performance. If the phase shift applied to different frequencies follows a linear behavior, the phase shift is referred to as “true time delay”. Common phase shifters, however, apply a constant phase offset for all frequencies.

For example, the phases of the common RF signal can be shifted by 0° at the bottom phase shifter 145i in FIG. 1A, by Δα at the next phase shifter 145i in the column, by 2Δα at the next phase shifter, and so on. As a result, the RF signals that arrive at amplifiers 124i (when transmitting, the amplifiers are power amplifiers “PAs”) are respectively phase-offset from each other. The PAs 124i amplify these phase-offset RF signals, and antenna elements 122i emit the RF signals S as electromagnetic waves.

Because of the phase offsets, the RF signals from individual antenna elements 122i are combined into outgoing wave fronts that are inclined at angle ϕ from the antenna aperture 110 formed by the lattice of antenna elements 122i. The angle ϕ is called an angle of arrival (AoA) or a beamforming angle. Therefore, the choice of the phase offset Δα determines the radiation pattern of the combined signals S defining the wave front. In FIG. 1B, an exemplary phased array antenna radiation pattern of signals S from an antenna aperture 110 in accordance with one embodiment of the present disclosure is provided.

Following the receiving direction of arrow RX in the schematic illustration of FIG. 1A, in a receiving phased array antenna system 100, the signals S defining the wave front are detected by individual antenna elements 122i, and amplified by amplifiers 124i (when receiving signals the amplifiers are low noise amplifiers “LNAs”). For any non-zero AoA, signals S comprising the same wave front reach the different antenna elements 122i at different times. Therefore, the received signal will generally include phase offsets from one antenna element of the receiving (RX) antenna element to another. Analogously to the emitting phased array antenna case, these phase offsets can be adjusted by phase shifters 145i in the beamformer lattice 140. For example, each phase shifter 145i (e.g., a phase shifter chip) can be programmed to adjust the phase of the signal to the same reference, such that the phase offset among the individual antenna elements 122i is canceled in order to combine the RF signals corresponding to the same wave front. As a result of this constructive combining of signals, a higher signal to noise ratio (SNR) can be attained on the received signal, which results in increased channel capacity.

Still referring to FIG. 1A, a mapping system 130 may be disposed between the antenna lattice 120 and the beamformer lattice 140 to provide length matching for equidistant electrical connections between each antenna element 122i of the antenna lattice 120 and the phase shifters 145i in the beamformer lattice 140, as will be described in greater detail below. A multiplex feed or hierarchical network 150 may be disposed between the beamformer lattice 140 and the distributor/combiner 160 to distribute a common RF signal to the phase shifters 145i of the beamformer lattice 140 for respective appropriate phase shifting and to be provided to the antenna elements 122i for transmission, and to combine RF signals received by the antenna elements 122i, after appropriate phase adjustment by the beamformers 142i.

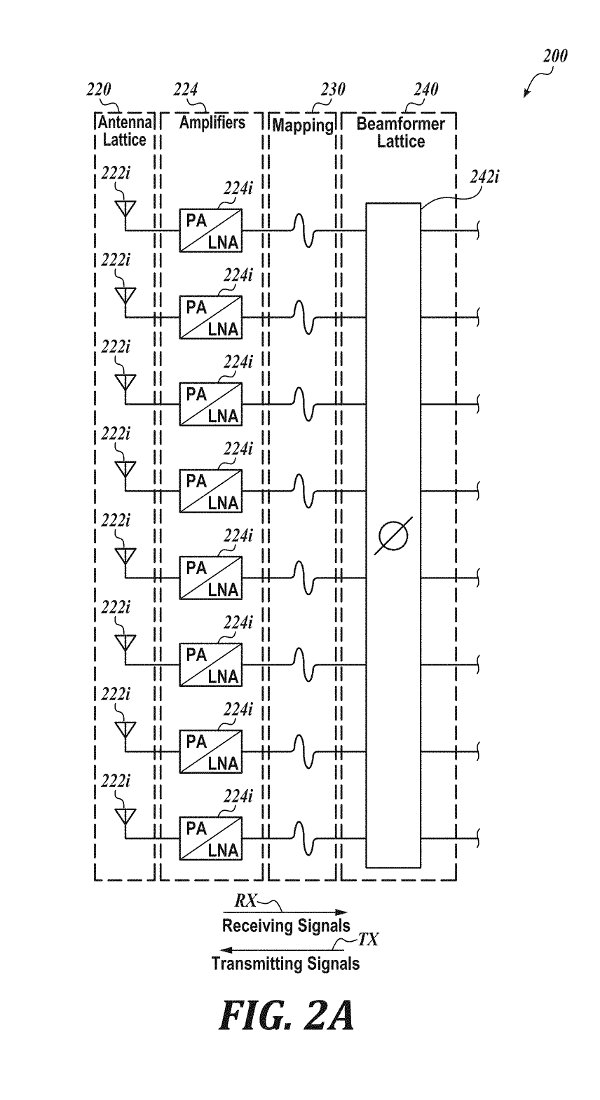

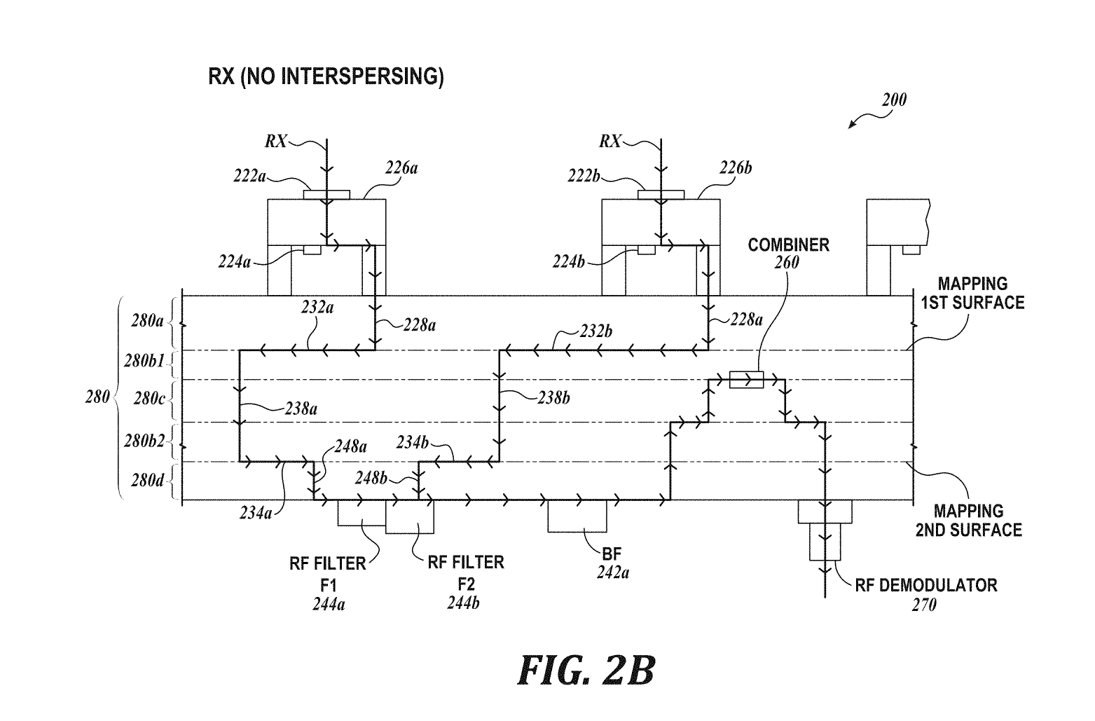

In accordance with some embodiments of the present disclosure, the antenna elements 122i and other components of the phased array antenna system 100 may be contained in an antenna module to be carried by the carrier 112. (See, for example, antenna modules 226a and 226b in FIG. 2B). In the illustrated embodiment of FIG. 2B, there is one antenna element 122i per antenna module 226a. However, in other embodiments of the present disclosure, antenna modules 226a may incorporate more than one antenna element 122i.

Referring to FIGS. 1D and 1E, an exemplary configuration for an antenna aperture 120 in accordance with one embodiment of the present disclosure is provided. In the illustrated embodiment of FIGS. 1D and 1E, the plurality of antenna elements 122i in the antenna lattice 120 are distributed with a space taper configuration on the carrier 112. In accordance with a space taper configuration, the number of antenna elements 122i changes in their distribution from a center point of the carrier 112 to a peripheral point of the carrier 112. For example, compare spacing between adjacent antenna elements 122i, D1 to D2, and compare spacing between adjacent antenna elements 122i, d1, d2, and d3. Although shown as being distributed with a space taper configuration, other configurations for the antenna lattice are also within the scope of the present disclosure.

The system 100 includes a first portion carrying the antenna lattice 120 and a second portion carrying a beamformer lattice 140 including a plurality of beamformer elements. As seen in the cross-sectional view of FIG. 1E, multiple layers of the carrier 112 carry electrical and electromagnetic connections between elements of the phased array antenna system 100. In the illustrated embodiment, the antenna elements 122i are located the top surface of the top layer and the beamformer elements 142i are located on the bottom surface of the bottom layer. While the antenna elements 122i may be configured in a first arrangement, such as a space taper arrangement, the beamformer elements 142i may be arranged in a second arrangement different from the antenna element arrangement. For example, the number of antenna elements 122i may be greater than the number of beamformer elements 142i, such that multiple antenna elements 122i correspond to one beamformer element 142i. As another example, the beamformer elements 142i may be laterally displaced from the antenna elements 122i on the carrier 112, as indicated by distance M in FIG. 1E. In one embodiment of the present disclosure, the beamformer elements 142i may be arranged in an evenly spaced or organized arrangement, for example, corresponding to an H-network, or a cluster network, or an unevenly spaced network such as a space tapered network different from the antenna lattice 120. In some embodiments, one or more additional layers may be disposed between the top and bottom layers of the carrier 112. Each of the layers may comprise one or more PCB layers.

Referring to FIG. 1F, a graph of a main lobe Lm and side lobes Ls of an antenna signal in accordance with embodiments of the present disclosure is provided. The horizontal (also the radial) axis shows radiated power in dB. The angular axis shows the angle of the RF field in degrees. The main lobe Lm represents the strongest RF field that is generated in a preferred direction by a phased array antenna system 100. In the illustrated case, a desired pointing angle D of the main lobe Lm corresponds to about 20°. Typically, the main lobe Lm is accompanied by a number of side lobes Ls. However, side lobes Ls are generally undesirable because they derive their power from the same power budget thereby reducing the available power for the main lobe Lm. Furthermore, in some instances the side lobes Ls may reduce the SNR of the antenna aperture 110. Also, side lobe reduction is important for regulation compliance.

One approach for reducing side lobes Ls is arranging elements 122i in the antenna lattice 120 with the antenna elements 122i being phase offset such that the phased array antenna system 100 emits a waveform in a preferred direction D with reduced side lobes. Another approach for reducing side lobes Ls is power tapering. However, power tapering is generally undesirable because by reducing the power of the side lobe Ls, the system has increased design complexity of requiring of “tunable and/or lower output” power amplifiers.

In addition, a tunable amplifier 124i for output power has reduced efficiency compared to a non-tunable amplifier. Alternatively, designing different amplifiers having different gains increases the overall design complexity and cost of the system.

Yet another approach for reducing side lobes Ls in accordance with embodiments of the present disclosure is a space tapered configuration for the antenna elements 122i of the antenna lattice 120. (See the antenna element 122i configuration in FIGS. 1C and 1D.) Space tapering may be used to reduce the need for distributing power among antenna elements 122i to reduce undesirable side lobes Ls. However, in some embodiments of the present disclosure, space taper distributed antenna elements 122i may further include power or phase distribution for improved performance.

In addition to undesirable side lobe reduction, space tapering may also be used in accordance with embodiments of the present disclosure to reduce the number of antenna elements 122i in a phased array antenna system 100 while still achieving an acceptable beam B from the phased array antenna system 100 depending on the application of the system 100. (For example, compare in FIG. 1C the number of space-tapered antenna elements 122i on carrier 112D with the number of non-space tapered antenna elements 122i carrier by carrier 112B.)

FIG. 1G depicts an exemplary configuration of the phased array antenna system 100 implemented as a plurality of PCB layers in lay-up 180 in accordance with embodiments of the present disclosure. The plurality of PCB layers in lay-up 180 may comprise a PCB layer stack including an antenna layer 180a, a mapping layer 180b, a multiplex feed network layer 180c, and a beamformer layer 180d. In the illustrated embodiment, mapping layer 180b is disposed between the antenna layer 180a and multiplex feed network layer 180c, and the multiplex feed network layer 180c is disposed between the mapping layer 180b and the beamformer layer 180d.

Although not shown, one or more additional layers may be disposed between layers 180a and 180b, between layers 180b and 180c, between layers 180c and 180d, above layer 180a, and/or below layer 180d. Each of the layers 180a, 180b, 180c, and 180d may comprise one or more PCB sub-layers. In other embodiments, the order of the layers 180a, 180b, 180c, and 180d relative to each other may differ from the arrangement shown in FIG. 1G. For instance, in other embodiments, beamformer layer 180d may be disposed between the mapping layer 180b and multiplex feed network layer 180c.

Layers 180a, 180b, 180c, and 180d may include electrically conductive traces (such as metal traces that are mutually separated by electrically isolating polymer or ceramic), electrical components, mechanical components, optical components, wireless components, electrical coupling structures, electrical grounding structures, and/or other structures configured to facilitate functionalities associated with the phase array antenna system 100. Structures located on a particular layer, such as layer 180a, may be electrically interconnected with vertical vias (e.g., vias extending along the z-direction of a Cartesian coordinate system) to establish electrical connection with particular structures located on another layer, such as layer 180d.

Antenna layer 180a may include, without limitation, the plurality of antenna elements 122i arranged in a particular arrangement (e.g., a space taper arrangement) as an antenna lattice 120 on the carrier 112. Antenna layer 180a may also include one or more other components, such as corresponding amplifiers 124i. Alternatively, corresponding amplifiers 124i may be configured on a separate layer. Mapping layer 180b may include, without limitation, the mapping system 130 and associated carrier and electrical coupling structures. Multiplex feed network layer 180c may include, without limitation, the multiplex feed network 150 and associated carrier and electrical coupling structures. Beamformer layer 180d may include, without limitation, the plurality of phase shifters 145i, other components of the beamformer lattice 140, and associated carrier and electrical coupling structures. Beamformer layer 180d may also include, in some embodiments, modulator/demodulator 170 and/or coupler structures. In the illustrated embodiment of FIG. 1G, the beamformers 142i are shown in phantom lines because they extend from the underside of the beamformer layer 180d.

Although not shown, one or more of layers 180a, 180b, 180c, or 180d may itself comprise more than one layer. For example, mapping layer 180b may comprise two or more layers, which in combination may be configured to provide the routing functionality discussed above. As another example, multiplex feed network layer 180c may comprise two or more layers, depending upon the total number of multiplex feed networks included in the multiplex feed network 150.

In accordance with embodiments of the present disclosure, the phased array antenna system 100 may be a multi-beam phased array antenna system. In a multi-beam phased array antenna configuration, each beamformer 142i may be electrically coupled to more than one antenna element 122i. The total number of beamformer 142i may be smaller than the total number of antenna elements 122i. For example, each beamformer 142i may be electrically coupled to four antenna elements 122i or to eight antenna elements 122i. FIG. 2A illustrates an exemplary multi-beam phased array antenna system in accordance with one embodiment of the present disclosure in which eight antenna elements 222i are electrically coupled to one beamformer 242i. In other embodiments, each beamformer 142i may be electrically coupled to more than eight antenna elements 122i.

FIG. 2B depicts a partial, close-up, cross-sectional view of an exemplary configuration of the phased array antenna system 200 of FIG. 2A implemented as a plurality of PCB layers 280 in accordance with embodiments of the present disclosure. Like part numbers are used in FIG. 2B as used in FIG. 1G with similar numerals, but in the 200 series.

In the illustrated embodiment of FIG. 2B, the phased array antenna system 200 is in a receiving configuration (as indicated by the arrows RX). Although illustrated as in a receiving configuration, the structure of the embodiment of FIG. 2B may be modified to be also be suitable for use in a transmitting configuration.

Signals are detected by the individual antenna elements 222a and 222b, shown in the illustrated embodiment as being carried by antenna modules 226a and 226b on the top surface of the antenna lattice layer 280a. After being received by the antenna elements 222a and 222b, the signals are amplified by the corresponding low noise amplifiers (LNAs) 224a and 224b, which are also shown in the illustrated embodiment as being carried by antenna modules 226a and 226b on a top surface of the antenna lattice layer 280a.

In the illustrated embodiment of FIG. 2B, a plurality of antenna elements 222a and 222b in the antenna lattice 220 are coupled to a single beamformer 242a in the beamformer lattice 240 (as described with reference to FIG. 2A). However, a phased array antenna system implemented as a plurality of PCB layers having a one-to-one ratio of antenna elements to beamformer elements or having a greater than one-to-one ratio are also within the scope of the present disclosure.

In the illustrated embodiment of FIG. 2B, the beamformers 242i are coupled to the bottom surface of the beamformer layer 280d.

In the illustrated embodiment, the antenna elements 222i and the beamformer elements 242i are configured to be on opposite surfaces of the lay-up of PCB layers 280. In other embodiments, beamformer elements may be co-located with antenna elements on the same surface of the lay-up. In other embodiments, beamformers may be located within an antenna module or antenna package.

As previously described, electrical connections coupling the antenna elements 222a and 222b of the antenna lattice 220 on the antenna layer 280a to the beamformer elements 242a of the beamformer lattice 240 on the beamformer layer 280d are routed on surfaces of one or more mapping layers 280b1 and 280b2 using electrically conductive traces. Exemplary mapping trace configurations for a mapping layer are provided in layer 130 of FIG. 1G.

In the illustrated embodiment, the mapping is shown on top surfaces of two mapping layers 280b1 and 280b2. However, any number of mapping layers may be used in accordance with embodiments of the present disclosure, including a single mapping layer. Mapping traces on a single mapping layer cannot cross other mapping traces. Therefore, the use of more than one mapping layer can be advantageous in reducing the lengths of the electrically conductive mapping traces by allowing mapping traces in horizontal planes to cross an imaginary line extending through the lay-up 280 normal to the mapping layers and in selecting the placement of the intermediate vias between the mapping traces.

In addition to mapping traces on the surfaces of layers 280b1 and 280b2, mapping from the antenna lattice 220 to the beamformer lattice 240 further includes one or more electrically conductive vias extending vertically through one or more of the plurality of PCB layers 280.

In the illustrated embodiment of FIG. 2B, a first mapping trace 232a between first antenna element 222a and beamformer element 242a is formed on the first mapping layer 280b1 of the lay-up of PCB layers 280. A second mapping trace 234a between the first antenna element 222a and beamformer element 242a is formed on the second mapping layer 280b2 of the lay-up of PCB layers 280. An electrically conductive via 238a connects the first mapping trace 232a to the second mapping trace 234a. Likewise, an electrically conductive via 228a connects the antenna element 222a (shown as connecting the antenna module 226a including the antenna element 222a and the amplifier 224a) to the first mapping trace 232a. Further, an electrically conductive via 248a connects the second mapping trace 234a to RF filter 244a and then to the beamformer element 242a, which then connects to combiner 260 and RF demodulator 270.

Of note, via 248a corresponds to via 148a and filter 244a corresponds to filter 144a, both shown on the surface of the beamformer layer 180d in the previous embodiment of FIG. 1G. In some embodiments of the present disclosure, filters may be omitted depending on the design of the system.

Similar mapping connects the second antenna element 222b to RF filter 244b and then to the beamformer element 242a. The second antenna element 222b may operate at the same or at a different value of a parameter than the first antenna element 222a (for example at different frequencies). If the first and second antenna elements 222a and 222b operate at the same value of a parameter, the RF filters 244a and 244b may be the same. If the first and second antenna elements 222a and 222b operate at different values, the RF filters 244a and 244b may be different.

Mapping traces and vias may be formed in accordance with any suitable methods. In one embodiment of the present disclosure, the lay-up of PCB layers 280 is formed after the multiple individual layers 280a, 280b, 280c, and 280d have been formed. For example, during the manufacture of layer 280a, electrically conductive via 228a may be formed through layer 280a. Likewise, during the manufacture of layer 280d, electrically conductive via 248a may be formed through layer 280d. When the multiple individual layers 280a, 280b, 280c, and 280d are assembled and laminated together, the electrically conductive via 228a through layer 280a electrically couples with the trace 232a on the surface of layer 280b1, and the electrically conductive via 248a through layer 280d electrically couples with the trace 234a on the surface of layer 280b2.

Other electrically conductive vias, such as via 238a coupling trace 232a on the surface of layer 280b1 and trace 234a on the surface of layer 280b2 can be formed after the multiple individual layers 280a, 280b, 280c, and 280d are assembled and laminated together. In this construction method, a hole may be drilled through the entire lay-up 280 to form the via, metal is deposited in the entirety of the hole forming an electrically connection between the traces 232a and 234a. In some embodiments of the present disclosure, excess metal in the via not needed in forming the electrical connection between traces 232a and 234a can be removed by back-drilling the metal at the top and/or bottom portions of the via. In some embodiments, back-drilling of the metal is not performed completely, leaving a via “stub”. Tuning may be performed for a lay-up design with a remaining via “stub”. In other embodiments, a different manufacturing process may produce a via that does not span more than the needed vertical direction.

As compared to the use of one mapping layer, the use of two mapping layers 280b1 and 280b2 separated by intermediate vias 238a and 238b as seen in the illustrated embodiment of FIG. 2B allows for selective placement of the intermediate vias 238a and 238b. If these vias are drilled though all the layers of the lay-up 280, they can be selectively positioned to be spaced from other components on the top or bottom surfaces of the lay-up 280.

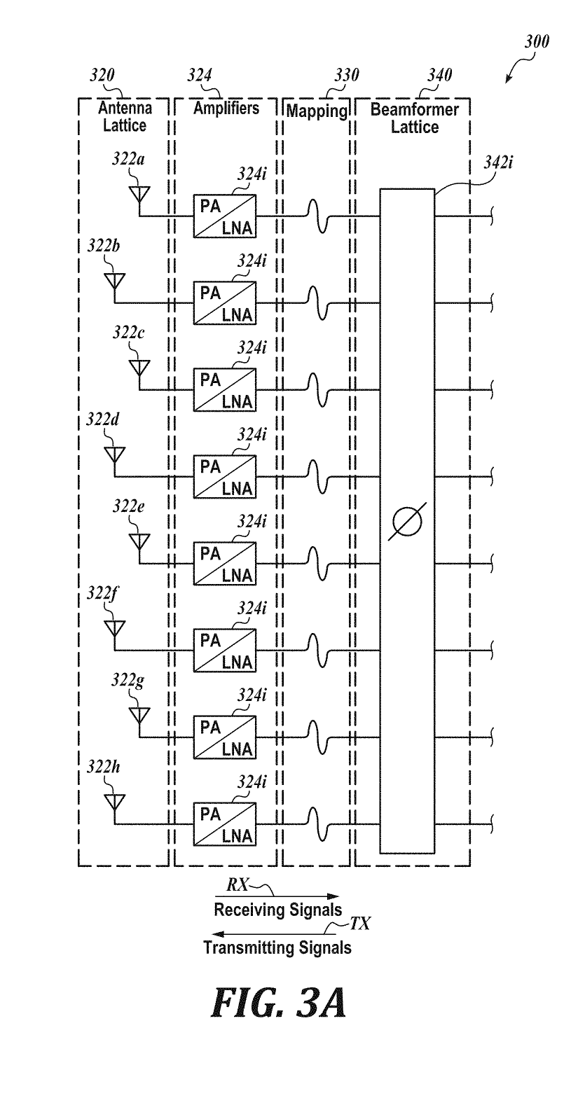

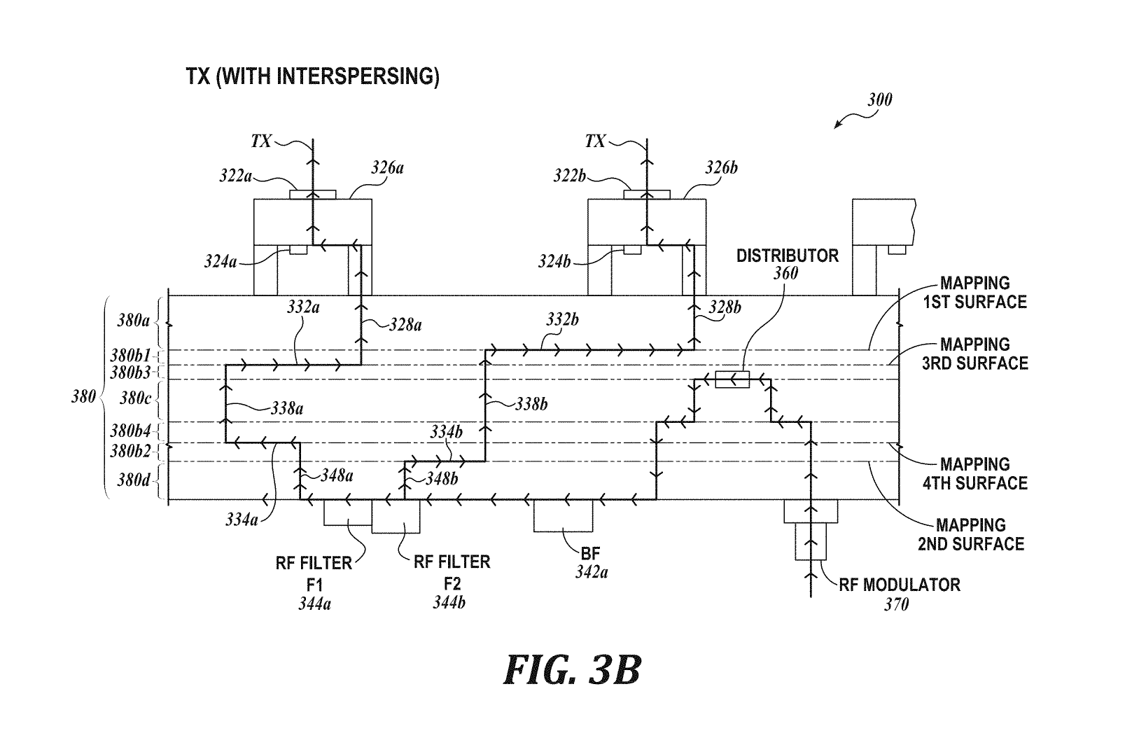

FIGS. 3A and 3B are directed to another embodiment of the present disclosure. FIG. 3A illustrates an exemplary multi-beam phased array antenna system in accordance with one embodiment of the present disclosure in which eight antenna elements 322i are electrically coupled to one beamformer 342i, with the eight antenna elements 322i being into two different groups of interspersed antenna elements 322a and 322b.

FIG. 3B depicts a partial, close-up, cross-sectional view of an exemplary configuration of the phased array antenna system 300 implemented as a stack-up of a plurality of PCB layers 380 in accordance with embodiments of the present disclosure. The embodiment of FIG. 3B is similar to the embodiment of FIG. 2B, except for differences regarding interspersed antenna elements, the number of mapping layers, and the direction of signals, as will be described in greater detail below. Like part numbers are used in FIG. 3B as used in FIG. 3A with similar numerals, but in the 300 series.

In the illustrated embodiment of FIG. 3B, the phased array antenna system 300 is in a transmitting configuration (as indicated by the arrows TX). Although illustrated as in a transmitting configuration, the structure of the embodiment of FIG. 3B may be modified to also be suitable for use in a receiving configuration.

In some embodiments of the present disclosure, the individual antenna elements 322a and 322b may be configured to receive and/or transmit data at different values of one or more parameters (e.g., frequency, polarization, beam orientation, data streams, receive (RX)/transmit (TX) functions, time multiplexing segments, etc.). These different values may be associated with different groups of the antenna elements. For example, a first plurality of antenna elements carried by the carrier is configured to transmit and/or receive signals at a first value of a parameter. A second plurality of antenna elements carried by the carrier are configured to transmit and/or receive signals at a second value of the parameter different from the first value of the parameter, and the individual antenna elements of the first plurality of antenna elements are interspersed with individual antenna elements of the second plurality of antenna elements.

As a non-limiting example, a first group of antenna elements may receive data at frequency f1, while a second group of antenna elements may receive data at frequency f2.

The placement on the same carrier of the antenna elements operating at one value of the parameter (e.g., first frequency or wavelength) together with the antenna elements operating at another value of the parameter (e.g., second frequency or wavelength) is referred to herein as “interspersing”. In some embodiments, the groups of antenna elements operating at different values of parameter or parameters may be placed over separate areas of the carrier in a phased array antenna. In some embodiments, at least some of the antenna elements of the groups of antenna elements operating at different values of at least one parameter are adjacent or neighboring one another. In other embodiments, most or all of the antenna elements of the groups of antenna elements operating at different values of at least one parameter are adjacent or neighboring one another.

In the illustrated embodiment of FIG. 3A, antenna elements 322a and 322b are interspersed antenna elements with first antenna element 322a communicating at a first value of a parameter and second antenna element 322a communicating at a second value of a parameter.

Although shown in FIG. 3A as two groups of interspersed antenna elements 322a and 322b in communication with a single beamformer 342a, the phased array antenna system 300 may be also configured such that one group of interspersed antenna elements communicate with one beamformer and another group of interspersed antenna elements communicate with another beamformer.

In the illustrated embodiment of FIG. 3B, the lay-up 380 includes four mapping layers 380b1, 380b2, 380b3, and 380b4, compared to the use of two mapping layers 280b1 and 280b2 in FIG. 2B. Mapping layers 380b1 and 380b2 are connected by intermediate via 338a. Mapping layers 380b3 and 380b4 are connected by intermediate via 338b. Like the embodiment of FIG. 2B, the lay-up 380 of the embodiment of FIG. 3B can allow for selective placement of the intermediate vias 338a and 338b, for example, to be spaced from other components on the top or bottom surfaces of the lay-up 380.

The mapping layers and vias can be arranged in many other configurations and on other sub-layers of the lay-up 180 than the configurations shown in FIGS. 2B and 3B. The use of two or more mapping layers can be advantageous in reducing the lengths of the electrically conductive mapping traces by allowing mapping traces in horizontal planes to cross an imaginary line extending through the lay-up normal to the mapping layers and in selecting the placement of the intermediate vias between the mapping traces. Likewise, the mapping layers can be configured to correlate to a group of antenna elements in an interspersed configuration. By maintaining consistent via lengths for each grouping by using the same mapping layers for each grouping, trace length is the only variable in length matching for each antenna to beamformer mapping for each grouping.

### Self-Multiplexing Antenna

To increase the number of beams transmitted or received from an antenna aperture, embodiments of the present disclosure include phased array antenna systems including a plurality of vertically stacked antenna elements. A vertical stack of individual antenna elements may also be referred to as a “self-multiplexing antenna.” In some embodiments of the present disclosure, a second antenna element is stacked with the first antenna element to be at least partially vertically aligned with a first antenna element. In some embodiments of the present disclosure, the second antenna element is stacked and concentric with the first antenna element.

Each antenna element in the stack may include an antenna patch and a ground plane or ground reflector. A patch antenna (also known as a microstrip antenna) is a type of radio antenna with a low profile, which can be mounted on a flat surface. A patch antenna may be a flat sheet or “patch” of metal, mounted over a larger sheet of a metal ground reflector.

In some embodiments, antenna patches can be mounted on a carrier, for example, on a printed circuit board (PCB), with the substrate defining the dielectric of the patch. In other embodiments, antenna patches may be mounted on or within an antenna package (such as an antenna module 226 as shown in FIG. 2B), which then may be mounted on a carrier, such as a PCB. The antenna package itself may also be a printed circuit board (PCB), with the substrate defining the dielectric of the patch. In all embodiments described herein, the feature on which the stacked antenna elements are mounted will be called the “carrier” or “substrate”, whether the carrier or substrate is a board, such as a PCB, or an antenna package, such as an antenna module. In some embodiments, the surface of the PCB on which the antenna package is mounted may be a ground plane.

In each antenna element, the distance between the patch and the ground reflector—dielectric height h—determines the bandwidth of the antenna. The ground reflector generally extends beyond the edges of the patch for proper operation. A ground reflector that is too small will result in a reduced front to back ratio. The center conductor of a coaxial line serves as the feed probe to couple electromagnetic energy in and/or out of the patch.

In operation, the individual antenna elements in the stack may receive and/or transmit data at different parameters (e.g., different frequencies, polarization angles, time multiplexing segments, etc.) to decrease coupling between antenna elements. For example, a first antenna element in the stack may transmit data at frequency f1, while a second antenna element in the stack may transmit data at frequency f2.

In general, some power may leak from one antenna element to another antenna element in a stack operating at nominally different values of a parameter (for example, operating at different frequencies). Even when an individual antenna in the stack primarily operates at one value of the parameter, e.g., frequency f1, that antenna may retain some sensitivity to another value of the parameter that is primarily associated with another antenna in the stack, e.g., frequency f2. Therefore, in some embodiments, filters are used to limit the cross-talk between the individual antenna elements in the stack, as described in greater detail below. In some embodiments, the filters may be constructed within the same footprint that is already occupied by the stack, which further minimizes the overall size of the phased array antenna.

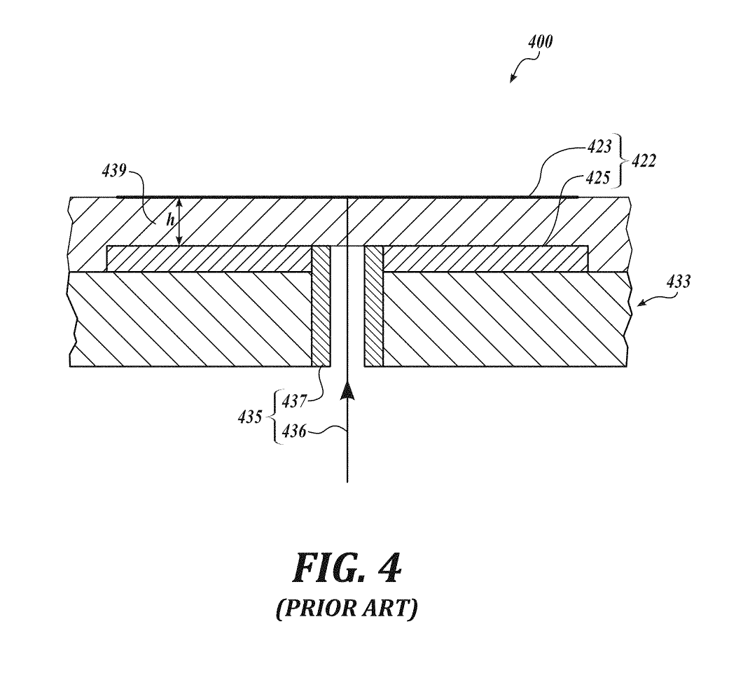

FIG. 4 is a cross-sectional view of the individual antenna element 422 in basic form in accordance with conventional technology. The individual antenna element 422 includes an antenna patch 423 and a ground reflector 425. The antenna patch 423 is typically a sheet of metal, for example, a sheet of copper. The ground reflector 425 can also be a sheet of metal, spaced from the antenna patch 423 by a dielectric layer 439 having a height h. The patch 423 and the ground reflector 425 are disposed on a substrate 433, such as a PCB substrate.

In operation, the antenna patch 423 receives radio frequency (RF) signals through an antenna feed 435 and emits RF signals (thorough the resonator formed by the antenna patch 423 and the ground reflector 425). Generally, the characteristic dimension of the antenna patch 423 is selected to promote a specific radio frequency (RF) of the signal. The antenna feed 435 can be a coaxial line including a center conductor 436 placed with respect to an outer shielding 437 to reduce noise coming into the antenna feed 435.

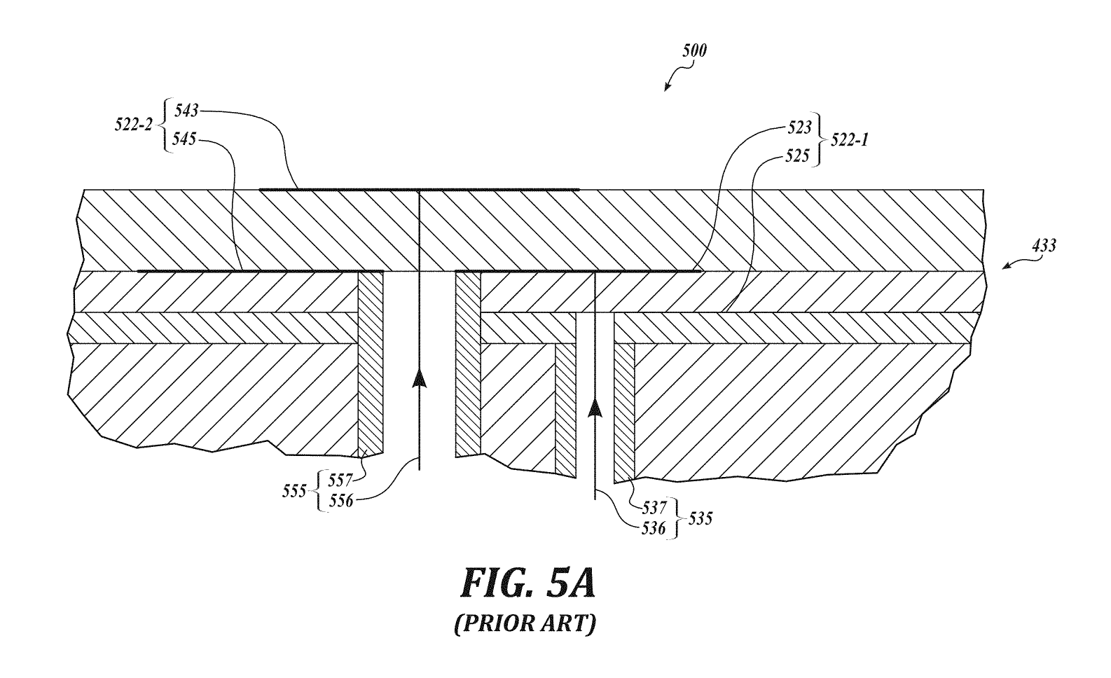

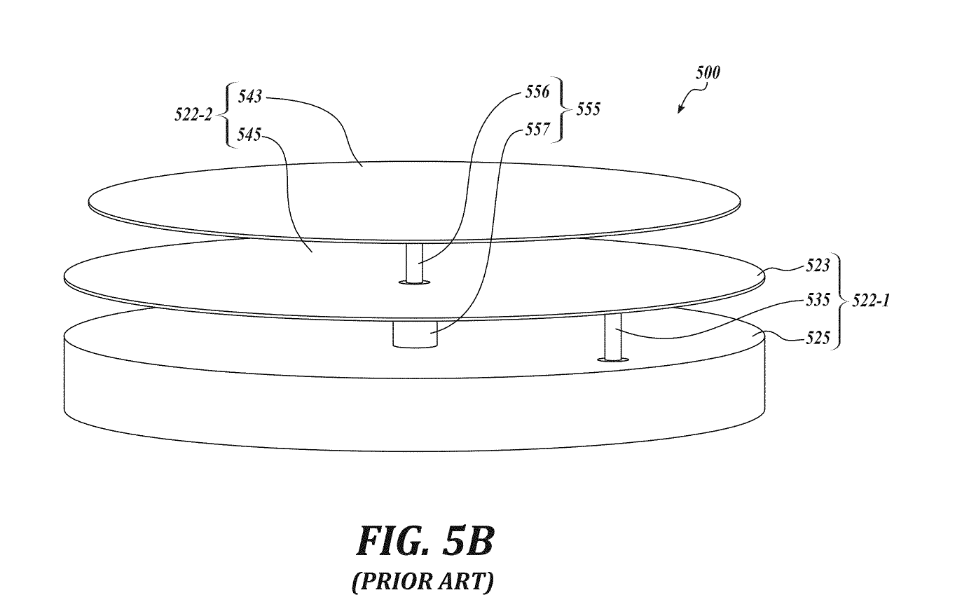

In some applications, a plurality of antenna elements can be used to increase power of the main lobe and/or decrease power of the side lobes and to increase the number of beams (communication links) of a phased array antenna system. As a result, the overall size of the phased array antenna and the number of antenna elements can become significant, which drives up the cost and size of the phased array antenna system. Therefore, in some phased array antenna systems, the individual antenna elements can be stacked on top of each other to reduce the overall area of the carrier and to increase the capacity of the system by increasing the number of beams transmitted and/or received by the system. An example of the conventional stacking of the antenna elements is described with reference to FIGS. 5A and 5B below.

FIG. 5A is a cross-sectional view of a stack 500 of antenna elements in accordance with conventional technology. The illustrated stack includes first and second antenna elements 522-1 and 522-2. The first antenna element 522-1 includes an antenna patch 523 and a ground reflector 525. An antenna feed 535 provides RF signals to the antenna 523

The second antenna element 522-2 is stacked over the first antenna element 522-1. The antenna patch 543 of the second antenna element 522-2 uses the antenna patch 523 of the first antenna element as its ground reflector.

The individual antennas 522-1 and 522-2 receive their corresponding RF signals through signal feeds 535 and 555. Typically, the first (lower and larger) antenna element 522-1 operates at an RF frequency that is lower than that of the second (upper and smaller) antenna element 522-2, because the size of the antenna patch of the antenna scales inversely proportionally with the operating frequency of the antenna element.

FIG. 5B is an isometric view of a stack of antenna elements of FIG. 5A. In the illustrated view, the material of the carrier 533 (shown in FIG. 5A) is not shown for the clarity of the view. The illustrated first and second antenna patches 523 and 543 and the ground reflector 525 are circular, but other shapes are also possible. For example, the patches and ground reflector may be rectangular.

In view of the stacking of antenna elements, the increase in the number of antenna elements does not require an incremental increase of the surface area of the carrier (also referred to as “footprint” or “real estate” in the industry). However, stacking individual antenna elements may cause electromagnetic interference or power coupling between the antennas in the stack (also referred to as “cross-talk” or “leakage”). Generally, such electromagnetic interference reduces the efficiency of the antenna elements. Accordingly, it would be advantageous to provide stacks of the individual antenna elements that result in reduced interference and reduced power dissipation from the antenna elements. Furthermore, it would be advantageous to provide improved phased array antennas having an increased number of beams without an increase in surface area of the carrier.

Such interference can be problematic at low fractional bandwidth. For example, when you have two resonant antennas on the same side of a carrier (side by side or having a vertical overlay) having center frequencies f1 and f2. As the fractional bandwidth [2(f1−f2)/(f1+f2)] gets larger, the coupling between the antennas can become smaller. Therefore, filtering techniques can be used for one or both of the antennas to further suppress the coupling. Moreover, frequency planning can be used to increase the fractional bandwidth between interspersed antenna elements on the same side of a carrier.

In a non-limiting exemplary, TABLE 1 below provides an exemplary channel configuration a Ku-Band downlink of 10.7 GHz to 12.7 GHz, having a total band spread of 2 GHz. When divided into eight channels with each channel representing 250 MHz, and each channel having respective center frequencies (fc) listed in TABLE 2 below.

TABLE 1
Eight Channels in Ku-Band downlink of 10.7 GHz to 12.7 GHz
Frequency Allocation for 10.7 GHz to 12.7 GHz Band

| Ch 1 | Ch 2 | Ch 3 | Ch 4 | Ch 5 | Ch 6 | Ch 7 | Ch 8 |
|---|---|---|---|---|---|---|---|
| 10.825 | 11.075 | 11.325 | 11.575 | 11.825 | 12.075 | 12.325 | 12.575 |
| 250 MHz | 250 MHz | 250 MHz | 250 MHz | 250 MHz | 250 MHz | 250 MHz | 250 MHz |
| Panel 1; | Panel 2; | Panel 1; | Panel 2; | Panel 1; | Panel 2; | Panel 1; | Panel 2; |
| Array 1 | Array 1 | Array 2 | Array 2 | Array 3 | Array 3 | Array 4 | Array 4 |

In a non-limiting example, the antenna elements may be divided between two panels, Panel 1 and Panel 2, each having two different types of antenna modules, AIP1 and AIP2 on panel 1 and AIP3 and AIP4 on panel 2. In the illustrated example, each antenna module includes two self-diplexing antenna elements.

Frequency planning can be used to increase the fractional bandwidth between vertically stacked antenna elements on the same side of a carrier. In the illustrated example (8-channel case, TABLE 1), the following frequency planning set out in TABLE 2 below can be used to establish at least a 750 MHz guard-band (edge-to-edge) difference between operational bands of antenna elements on the same side of a carrier having a vertical overlay. In this example (e.g. Ch-1 & Ch-5 on AIP-1), the fractional guard-band is 750 MHz divided by the center frequency (11.325 GHz) of the channel pair, which equals a fractional bandwidth of 6.6%. Such fractional bandwidth

TABLE 2
Frequency planning of 10.7 GHz to 12.7 GHz

| Panel 1 | | | | Panel 2 | | | |
|---|---|---|---|---|---|---|---|
| AIP 1 | | AIP 2 | | AIP 3 | | AIP 4 | |
| Ch 1 | Ch 5 | Ch 3 | Ch 7 | Ch 2 | Ch 6 | Ch 4 | Ch 8 |
| 10.825 | 11.825 | 11.325 | 12.325 | 11.075 | 12.075 | 11.575 | 12.575 |

In one embodiment of the present disclosure, the fractional guard-band is greater than 4.5%. In one embodiment of the present disclosure, the fractional guard-band is greater than 5%. In another embodiment of the present disclosure, the fractional guard-band is greater than 6%. In another embodiment of the present disclosure, the fractional guard-band is greater than 7%.

In one embodiment, the guard-band maintains about 2% operational bandwidth for the first and second antennas around first frequency and second frequency, respectively. In other embodiment, the guard-band maintains up to 5% of the operational bandwidth for the first and second antennas around first frequency and second frequency, respectively.

### RF Choke/Isolator Cavity

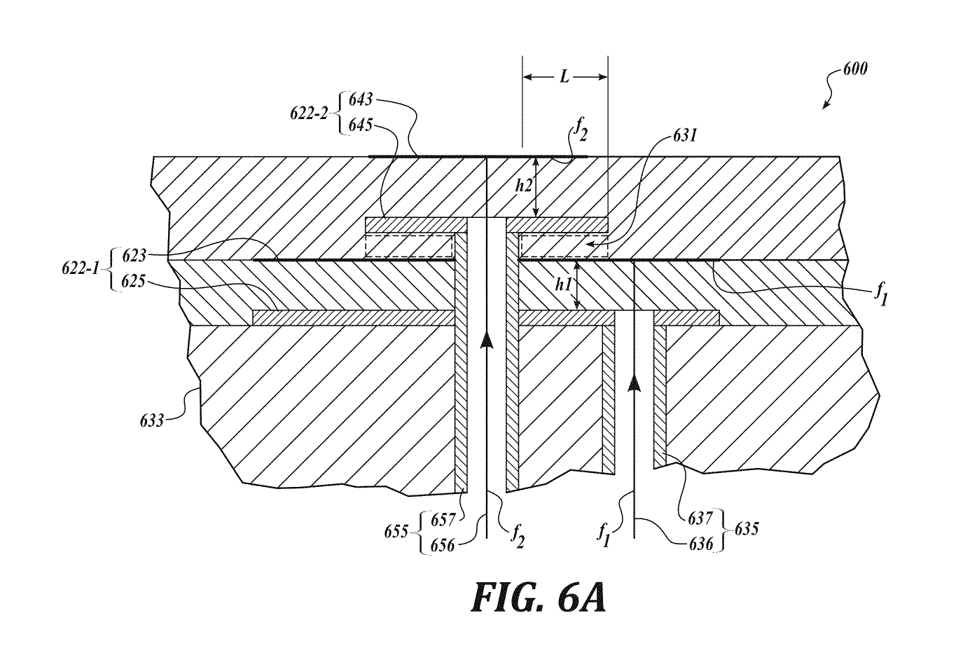

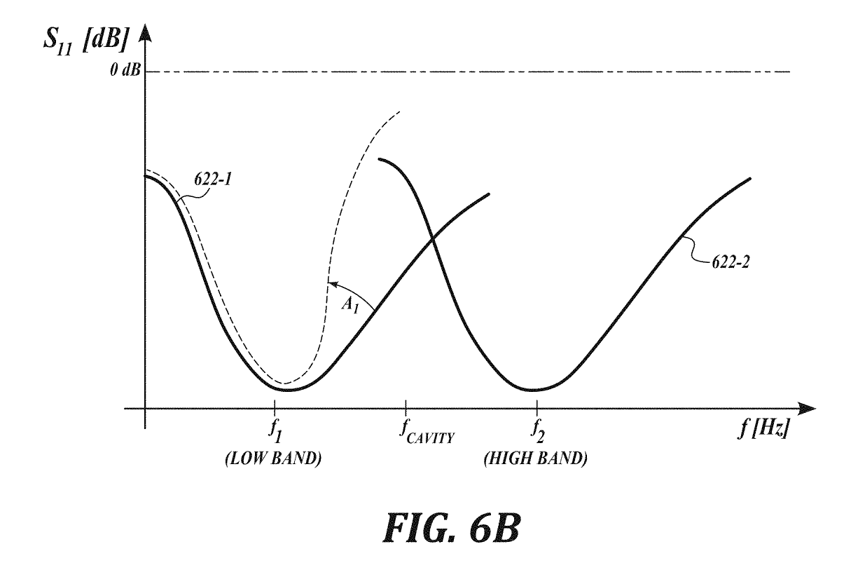

FIG. 6A is a cross-sectional view of a stack 600 of antenna elements in accordance with one embodiment of the present disclosure. The illustrated stack 600 of antenna elements (also referred to as an “antenna stack” or a “self-multiplexing antenna”) includes a second antenna element 622-2 stacked over a first antenna element 622-1.

The first antenna element 622-1 includes an antenna patch 623 and a ground reflector 625 spaced from the antenna patch 623 by a distance h1. Likewise, the second antenna element 622-2 includes an antenna patch 643 and a ground reflector 645 spaced from the antenna patch 643 by a distance h2. An isolator cavity 631, as discussed in greater detail below, is defined between the first and second antenna elements 622-1 and 622-2. The antenna patches and the ground reflectors may be portions of the routing layers (e.g., metal layers) between the pairs of the insulation layers (e.g., polymer, ceramic, etc.) of the carrier 633.

In some embodiments, the individual antennas may have different sizes. For example, the second antenna element 622-2 (which is the top antenna element in the configuration shown in FIG. 6) may be smaller in lateral area to reduce blockage of the electromagnetic waves received by or emitting from the first antenna element 622-1 (which is the bottom antenna element in the configuration shown in FIG. 6). The illustrated individual antenna elements 622-1 and 622-2 are shown as being generally concentric, but other arrangements of the individual antennas in the stack are also possible. For example, the individual antennas in the stack may be non-concentric.

The first and second antenna elements operate at different parameters. For example, the first antenna element 622-1 may receive signals at frequency f1 through a first antenna feed 635, and the second antenna element 622-2 may receive signals at frequency f2 through a second antenna feed 655.

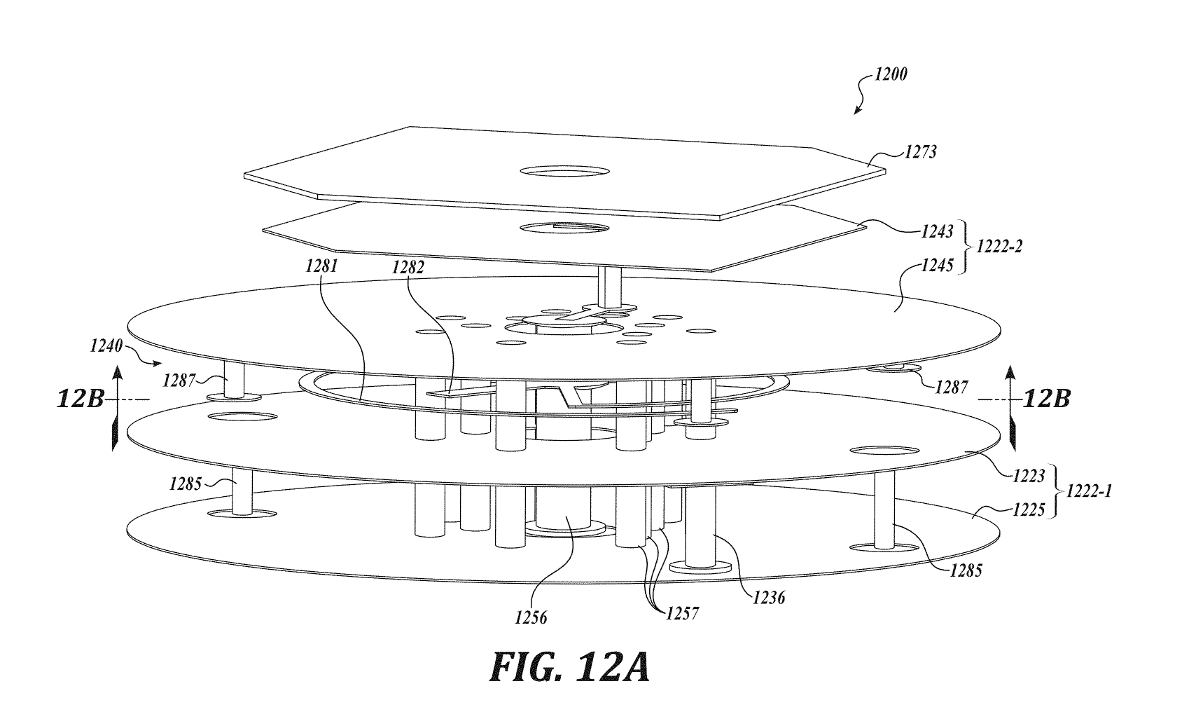

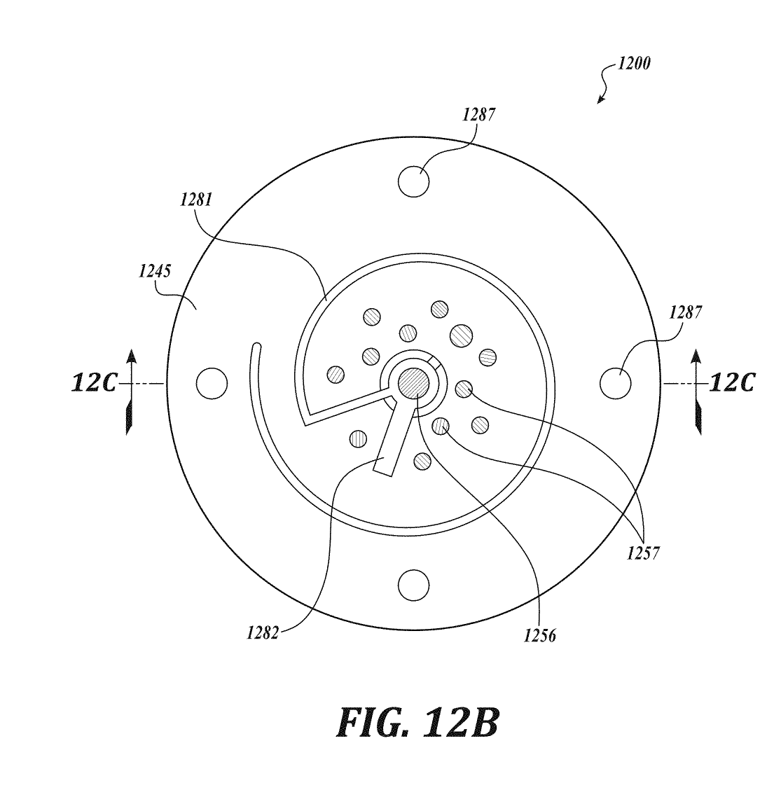

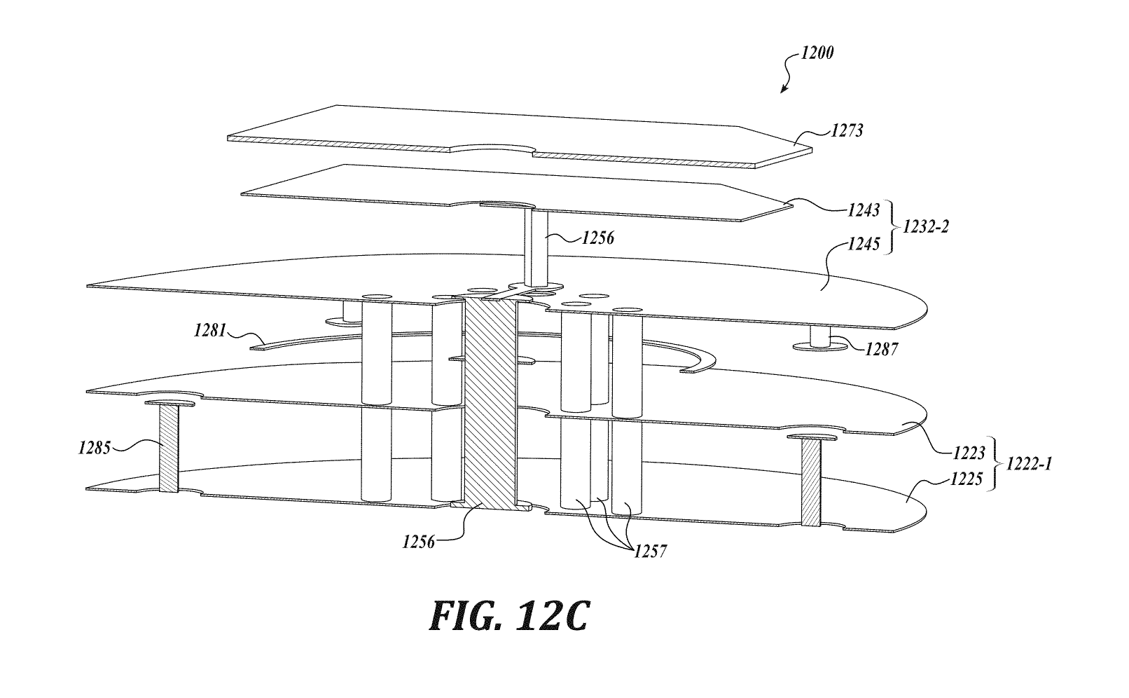

In some embodiments, the antenna feeds (also referred to as “signal feeds”) may include co-axial cables. For example, the antenna feed 635 for the first antenna element 622-1 in the illustrated embodiment includes a center conductor 636 which is shielded by 637. The shielding 637 may be connected to the ground reflector 625 for the first antenna element 622-1. Likewise, the shielding 657 may be connected to the ground reflector 645 for the second antenna element 622-2. In some embodiments, the shielding portions 637 and 657 may be metal-plated vias in the substrate 633 (see, e.g., exemplary shielding 1257 in FIG. 12A).

The first and second antenna elements 622-1 and 622-2 may simultaneously operate at frequencies f1 and f2 to or from a remote receiver and/or transmitter. As a result, the overall data bandwidth of the stack 600 is increased, while the footprint of the stacked antenna remains generally the same as it would be for a non-stacked antenna design.

The isolator cavity 631 between the first and second antenna elements 622-1 and 622-2 provides an RF choke (resonant type) to isolate the antenna elements and reduce electromagnetic coupling between the first and second antenna feeds 635 and 655. The isolation frequency of the cavity 631 is a function of the volume (as shown by “L” in FIG. 6A in one dimension) of the cavity 631, which is mostly determined by the overlapping area of the second antenna reflector 645 and the first antenna patch 623, and by the (outer/perimeter) size of the outer shielding 657 of the second antenna feed. The height (hc) of the cavity 631 causes fringing fields, which can affect the resonant frequency of the RF choke but the effect is less pronounced compared to other geometrical parameters mentioned before.

Typically, the resonant field inside the RF-choke is similar to the resonant field of a conventional patch antenna with equal cavity size operating at its first dominant mode. As a first order approximation; we can ignore the thickness of coaxial shield 657 of top antenna and the fringing effect between the second antenna reflector 645 and the first antenna patch 623. Assuming the second (top) antenna reflector 645 is of circular shape, L becomes the radius of the second antenna reflector 645 and the resonance frequency, fc, of the cavity can be found as follows;

$${f}_{c} \text{∼} \frac{1.84}{2 π L \sqrt{{ɛ}_{r}}}$$

ϵᵣ is the dielectric constant of the cavity medium

For a practical implementation, the coaxial shield 657 will occupy a finite volume inside the isolator cavity 631 and fc will be slightly above the value suggested by the equation, due to reduced cavity volume. Also for increasing thickness of the isolator cavity 631, the fringing effect around the perimeter of the isolator cavity 631 will decrease the resonance frequency, fc, slightly below the value suggested by the equation. The exact resonant frequency will also depend on the size of the first antenna patch 623 when it is close in diameter to the isolator cavity 631 in size/diameter.

FIG. 6B is a graph of scattering parameters S11 of the stack of the antenna elements shown in FIG. 6A. The horizontal axis shows operating frequency of the individual antenna elements 622-1 and 622-2. For example, the first antenna element 622-1 may operate at frequency f1=10.7 GHz, and the second antenna element 622-2 may operate at frequency f2=11.7 GHz. The vertical axis shows the scattering parameter S11 for each antenna. In general, it is desirable for the S11 to be small at the operating frequency of the individual antenna element, indicating a greater impedance mismatch efficiency. In the illustrated example, the S11 parameters for both antenna elements 622-1 and 622-2 are minimal at their respective operating frequencies f1, f2.

The solid line S11 curves for the first and second antenna elements 622-1 and 622-2 are exemplary S11 curves for an antenna stack without any filtering. In view of the filtering provided by the isolator cavity 631 shown and described with reference to FIG. 6A, the S11 for the first antenna element 622-1 curve becomes narrower around the preferred frequency by increasing the roll-off of the S11 away from the preferred frequency as indicated by the dotted line and arrow A1.

A relatively narrow r (reflection coefficient) for the individual antenna operating at frequency f1 indicates a high selectivity of that antenna for the signals at f1, and high rejection of the signals outside of the relatively narrow frequency range around f1. As a result, the individual antenna element operating at frequency f1 is less receptive to the frequencies away from f1. Generally, the relatively high selectivity of an individual antenna for its operating frequency makes the individual antenna element more immune to the frequencies outside of the preferred range. Accordingly, separation can be achieved between the resonators in the non-limiting example of the first antenna element 622-1 operating at frequency f1=10.7 GHz, and the second antenna element 622-2 operating at frequency f2=11.7 GHz. With improved separation, the overall signal-to-noise ratio (SNR) and the total efficiency of the antenna stack may be improved. In a non-limiting example of FIGS. 6A and 6B, the first antenna element 622-1 resonates in the low band (f1) between 10.7 and 10.95 GHz, and the second antenna element 622-2 resonates in the high band (f2) between 11.7 and 11.95 GHz. The isolating cavity 631 resonates at fc, where f1<fc<f2 (typically closer to f2). The exact location of fc affects the efficiency and radiation pattern of top and bottom antenna and it is therefore a design parameter depending on the specific PCB stack-up used to implement the overlaid antennas.

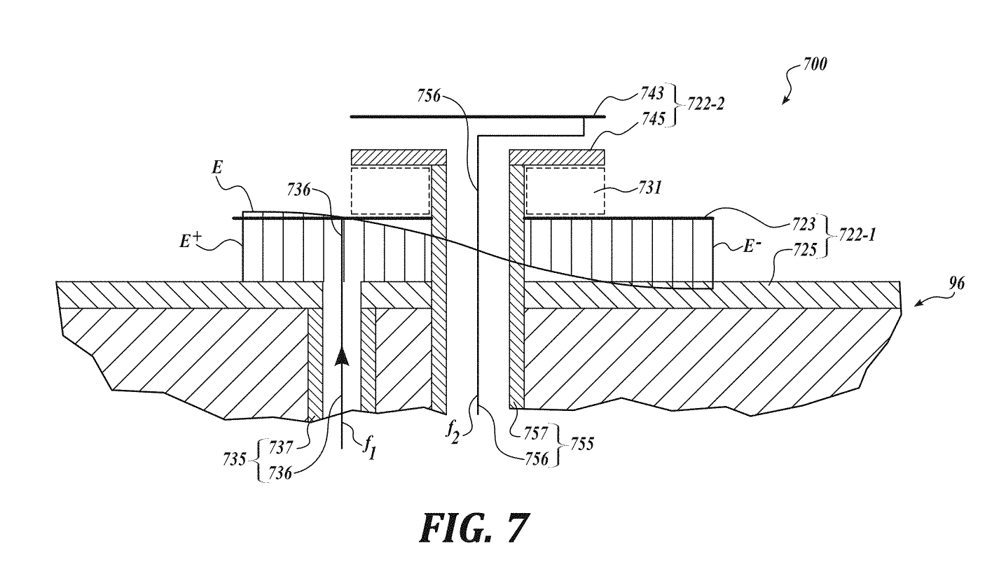

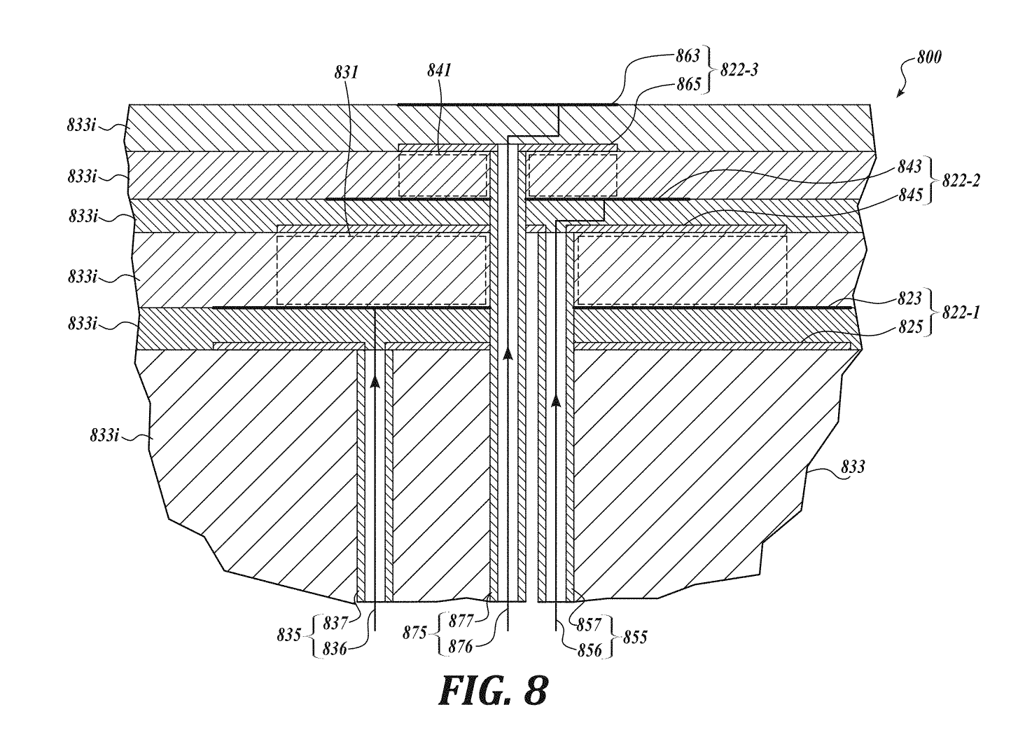

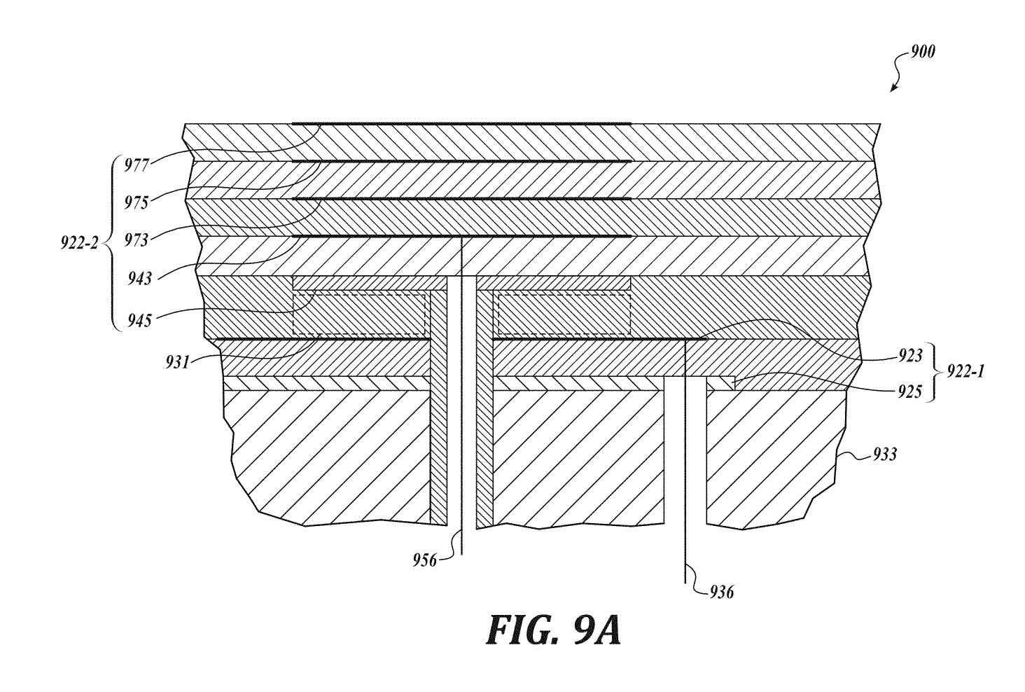

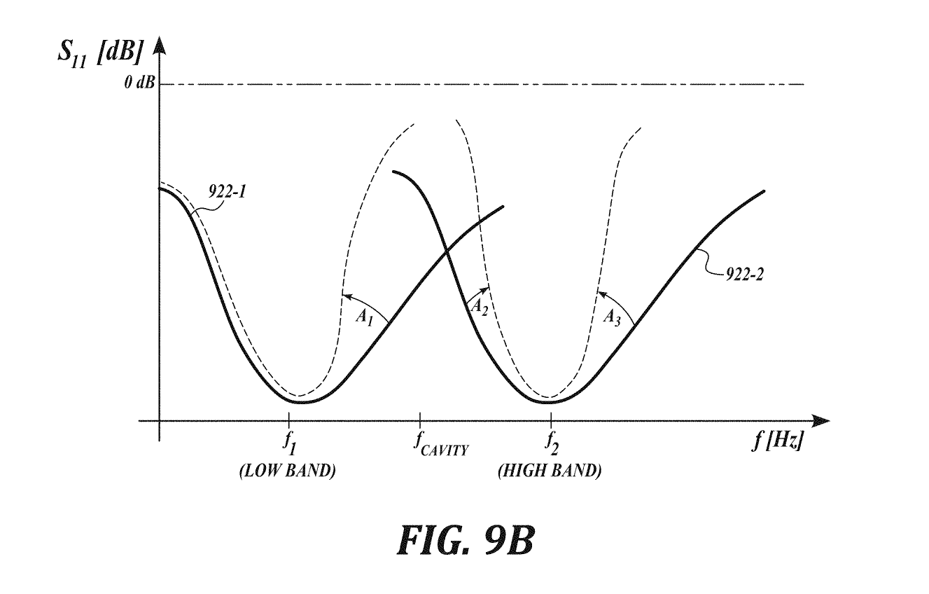

The RF choke (cavity 631), shown in FIG. 6A, provides isolation between the second (top) antenna element 622-2 and first (bottom) antenna element 622-1 at high band (f2). To further reduce the coupling at low band between antenna elements in an antenna stack, various other filtering techniques may be used in the stack, as described in greater detail below with reference to FIGS. 9A-12C. Prior to a discussion of filtering techniques, other antenna stack configurations are discussed below with reference to FIGS. 7 and 8.

### Routing Antenna Feed

FIG. 7 is a cross-sectional view of a stack 700 of antenna elements in accordance with another embodiment of the present disclosure including a sample graph of an electrical field E of the antenna stack 700. The antenna stack 700 includes first and second antenna elements 722-1 and 722-2 that receive signals through corresponding antenna feeds 735 and 755, respectively.

In operation, the individual antenna elements create an electrical field (E) in response to the excitation provided by the antenna feeds. For example, the first antenna element 722-1 creates an electrical field E inside the volume the first antenna patch 723 and the first antenna reflector 725 that, at the time of sampling, ranges from E=E+ at one side of the antenna, through E=0 at the geometrical center, to E=E− at the opposite side of the antenna. Even as the electrical field E changes as a function of time, the electrical field E may generally remain zero or close to zero at the geometrical center or close to the geometrical center of the antenna.

In some embodiments, the antenna feed for a subsequent second antenna may be routed at least partially through the areas of E=0 to minimize to mitigate the interference with the E-field profile and distribution of the first antenna 722-1. For example, in the illustrated embodiment of FIG. 7, the second feed line 755 of the second antenna element 722-2 passes through or close to the geometrical center of the first antenna element 722-1 such that the antenna feed 755 of the second antenna element 722-2 remains close to the E=0 zone of the first antenna element 722-1. As a result, the E-field distribution between the first antenna patch 723 and the first antenna reflector 725 (and therefore the efficiency and radiation pattern of first antenna 722-1) may remain unperturbed or minimally perturbed by the feed line 755 of second antenna 722-2.

In some embodiments, the center conductors may be connected to their respective antenna patches away from the center of the antenna patches to promote excitation of the antenna elements. For example, in the illustrated stack 700 in FIG. 7, the first and second center conductors 736 and 756 of the respective antenna feeds 735 and 755 connect off-center with their respective antenna patches 723 and 743.

### Three Antenna Elements

FIG. 8 is a cross-sectional view of a stack 800 of antenna elements in accordance with another embodiment of the present disclosure. The illustrated stack 800 includes three individual antennas elements 822-1, 822-2, and 822-3, but other numbers and configurations of the individual antennas elements in the stack are also possible. In some embodiments, the size of the individual antenna elements 822-1, 822-2, 822-3 decreases with each subsequent antenna (e.g., moving upward in the vertical direction in the illustrated embodiment) to reduce blocking of the electromagnetic waves transmitted from and/or received by each of the individual antenna elements in the stack 800.

As discussed above with reference to FIG. 7 and as shown in the illustrated embodiment of FIG. 8, in accordance with embodiments of the present disclosure, the antenna feeds of the subsequent individual antenna elements can be routed near to the geometrical center of the lower individual antennas to reduce perturbation of the E-field distribution across the related lower antenna volumes. For example, the second and third antenna feeds 855 and 875 for the respective second and third antenna elements 822-2 and 822-3 may be routed close to the geometrical center of the first antenna element 822-1. Likewise, the third antenna feed 875 for the third antenna element 822-3 may be routed close to the geometrical center of the second antenna element 822-2. For comparison, the first antenna feed 835 for first antenna element 822-1 is routed to the side of the geometrical center of the first antenna element 822-1.

### Parasitic Patches

In addition to reducing the leakage between the antenna pair 622-1 and 622-2 at the high band (f2) in the illustrated embodiment of FIG. 6, in some embodiments of the present disclosure, the antenna stack may be designed such that undesired leakage between the antenna pair at the low band (f1) can also be reduced.

FIG. 9A is a schematic view of a filtering scheme for a stack 900 of antenna elements in accordance with one embodiment of the present disclosure. The illustrated stack 1000 includes first and second antenna elements 922-1 and 922-2. In some embodiments, the antenna stack may also include one or more additional (also referred to as “parasitic patches”). In the illustrated embodiment, the antenna stack 900 includes three parasitic patches 973, 975, 977. However, depending on the design of the stack, one or two parasitic patches may be adequate. In addition, more than three parasitic patches are within the scope of the present disclosure.

In operation, the parasitic patches can be used to control the frequency response of the second (top) antenna 922-2 in the stack, as explained with reference to FIG. 9B below.

In the illustrated embodiment of FIG. 9A, the parasitic patches 973, 975, 977 are each a flat sheet or “patch” of metal, mounted over the antenna patch 943 away from the ground plane. In the illustrated embodiment, the patches and ground reflectors may be portions of the routing layers (e.g., metal layers) between insulation layers (e.g., polymer, ceramic, etc.) of the carrier 933.

In the illustrated embodiment, the sizes of the parasitic patches 973, 975, 977 can be chosen to get a specific frequency response from the second antenna element 922-2 but is typically smaller than the second antenna patch 943. As a result, the parasitic patches 973, 975, 977 do not require additional footprint of the carrier. However, other sizing for parasitic patches is within the scope of the present disclosure.

In the illustrated embodiment of FIG. 9A, the parasitic patches 973, 975, 977 are “floating”, which is a term to describe a state of being unconnected to the electrical ground. In other embodiments, the parasitic patches need not be free floating.

FIG. 9B is a graph of scattering parameters S11 of the stack of the antenna elements shown in FIG. 9A. The horizontal axis shows operating frequency of the individual antenna elements 922-1 and 922-2. For example, the first antenna element 922-1 may operate at frequency f1=10.7 GHz, and the second antenna element 922-2 may operate at frequency f2=11.7 GHz. The vertical axis shows the scattering parameter S11 for each antenna. In general, it is desirable for the S11 to be small at the operating frequency of the individual antenna element, indicating a relatively small reflection of the incoming signal at the operating frequency. In the illustrated example, the S11 parameters for both antenna elements 922-1 and 922-2 are minimal at their respective operating frequencies f1, f2.

The solid line S11 curves for the first and second antenna elements 922-1 and 922-2 are exemplary S11 curves for an antenna stack without any filtering. The antennas are still impedance matched in the other's operational band, resulting in resistive loading to each other, and therefore, decreased efficiency. In view of the filtering provided by the isolator cavity 931, the S11 curve for the first (bottom) antenna element 922-1 becomes narrower around f1 by increasing the roll-off of the S11 away from f2, the high band as indicated by the arrow A1. The S11 curve of the second (top) antenna element 922-2 can be shaped in a similar way (shown by arrows A2 and A3) by using the patches 943, 973, 975, 977 and the dielectric material filling between those patches. A relatively narrower band response for each antenna element prevents them from resistively loading each other during their operation, resulting in higher radiation efficiency.

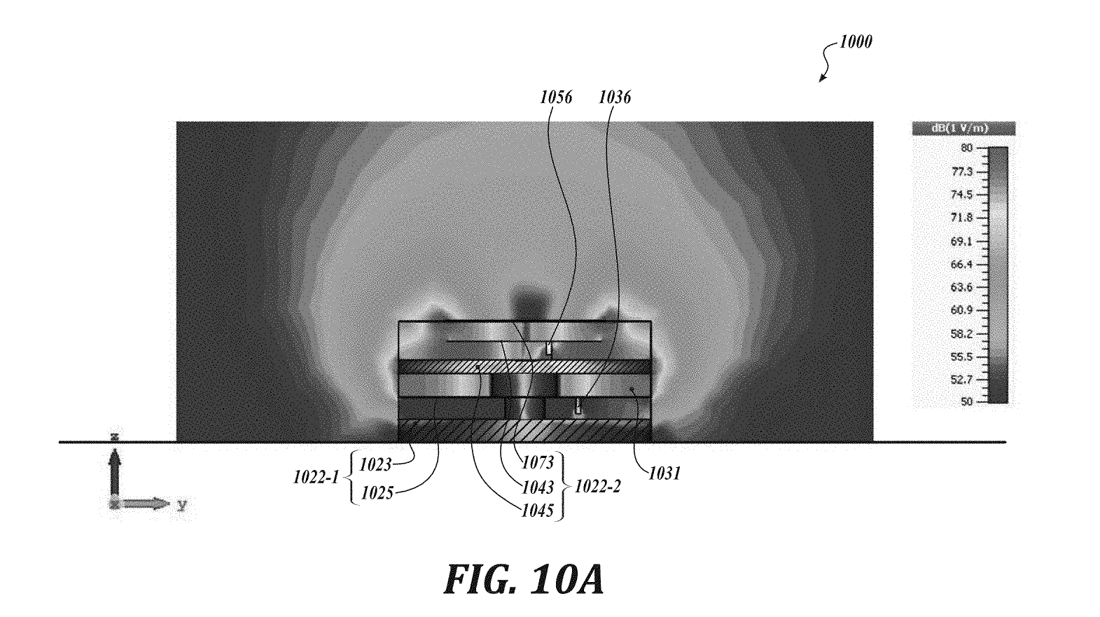

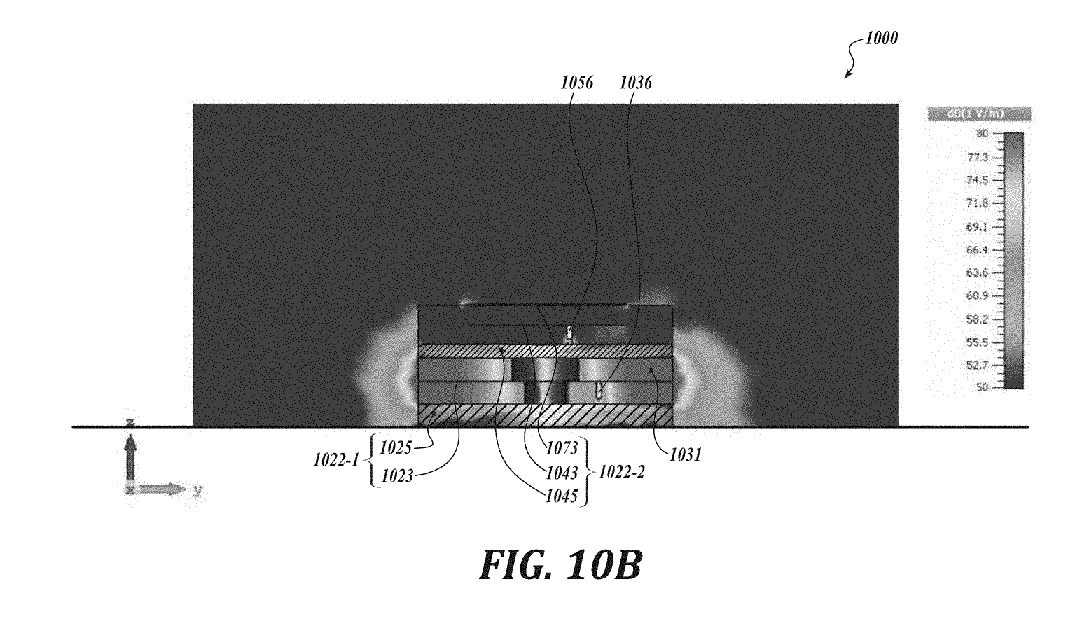

As described with reference to the simulation results in FIGS. 10A and 10B, separation can be achieved between the resonators in the non-limiting example of the first antenna element operating at frequency f1=10.7 GHz, and the second antenna element operating at frequency f2=11.7 GHz.

### Simulation Results: Effect of Isolator/Choke

As discussed above with reference to FIGS. 6A and 6B, the first antenna element 622-1 operates in the low band between 10.7 and 10.95 GHz, and the second antenna element 622-2 operate in the high band between 11.7 and 11.95 GHz. The isolator cavity 631 is sized to resonate at fc (10.95 GHz<fc<11.7 GHz). Further as discussed above with FIGS. 9A and 9B, in view of the filtering provided by one or more parasitic patches 973, 975, 977 (, the S11 for the second antenna element 922-2 curve becomes narrower around the preferred frequency by increasing the roll-off of the S11 away from the preferred frequency as indicated by the dotted line.

FIGS. 10A and 10B are simulation results (at high band) of RF signals of a stack 1000 of antenna elements in accordance with embodiments of the present disclosure. A comparison of FIGS. 10A and 10B two figures demonstrate the isolation mechanism provided by RF choke at high band. The antenna stack 1000 includes an isolator cavity 1031 between the first antenna element 1022-1 and the second antenna element 1022-2. The second antenna element 1022-2 has one parasitic patch 1073. For simplicity, the coaxial lines coming from the bottom side of the stack 1000 (below ground reflector 1025) are not included. Instead, small probes (vertical pins 1036 and 1056) with ideal gap sources are placed inside the antenna elements 1022-1 and 1022-2 for simulation purposes.

In FIG. 10A, the top antenna 1022-2 (its probe and gap source) is turned on at high band (f2) while bottom antenna probe is terminated by a resistive load (to represent the impedance of the coaxial line that will be connected to this probe in a realistic implementation). We note that, the cavity volume 1031 (the cavity between the second ground reflector 1045 and the first antenna patch 1023) supports a strong standing wave (because this is a resonant type choke, as mentioned before) but does not let the electromagnetic signal pass across its aperture towards bottom antenna volume, which is indicated by relatively darker shading of the first (bottom) antenna element 1022-1 between the first antenna patch 1023 and the first antenna reflector 1025. We also note that, the main electromagnetic radiation from the second (top) antenna element 1022-2 is towards broadside direction, as desired from this type of antenna, showing that the RF choke does not degrade the radiation pattern of the top antenna while isolating it from the bottom antenna at high band.

In FIG. 10B, the bottom antenna 1022-1 (its probe and gap source) is turned on at high band (f2) while the top antenna is terminated by a matched load (to represent the coaxial line impedance). As can be seen, there is no noticeable electromagnetic radiation leaving the antenna module since the RF-choke detunes the first (bottom) antenna element 1022-1 at high band (see FIG. 9B, arrow A1). Again, the isolator cavity 1031 (the cavity between the second ground reflector 1045 and the first antenna patch 1023) supports a strong standing wave but does not let the electromagnetic signal pass through its aperture towards top antenna volume, which is indicated by relatively darker shading of the second antenna element 1022-2 between the second antenna patch 1043 and the second antenna element 1045.

### Trace Filter

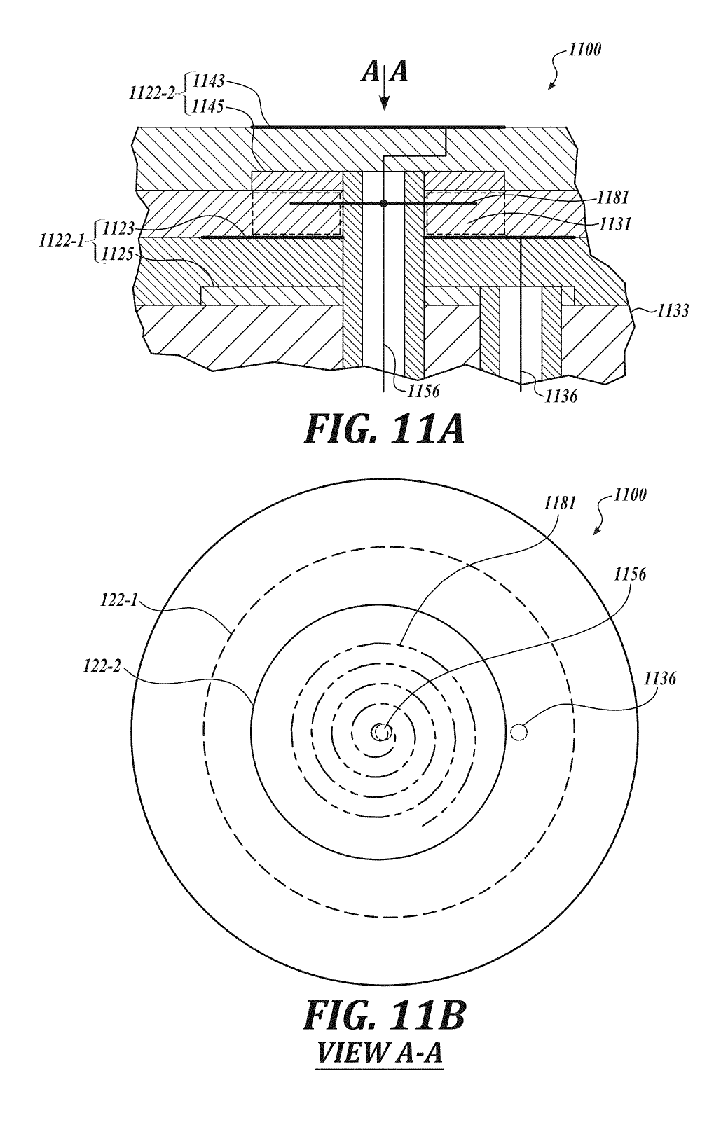

FIGS. 11A and 11B are schematic views of filtering schemes in accordance with one embodiment of the present disclosure. FIG. 11A shows a side, cross-sectional view of an antenna stack 1100 including first and second antenna elements 1122-1 and 1122-2, and FIG. 11B shows a top plan view of the antenna stack 1100. In the illustrated embodiment, the center conductor 1156 of the coaxial feed line of the second antenna element 1122-2 is connected to a meandered trace 1181 (which is a strip-line, using ground reflector 1145 and first (bottom) antenna patch 1123 as ground planes. The length of this trace can be chosen such that it becomes a notch filter and reduce the coupling between the signal lines 1156 and 1136 of the respective feed lines.

In some embodiments, the trace filter 1181 may be wound inside the space or cavity 1131 between the two individual antennas elements 1122-1 and 1122-2, therefore not requiring additional footprint on the carrier 1233. In some embodiments, the trace filter 1181 can be a conductive trace laid within a routing layer of the carrier 1133 (e.g., PCB or a ceramic carrier).

In some embodiments, the length of the trace filter 1181 can be selected to filter out undesired frequencies. For example, the trace filter 1181 may filter the frequency f1 emitted by the first (bottom) antenna element 1122-1, while not filtering frequency f2 of the second (top) antenna element 1122-2.

In some embodiments, the illustrated trace filter 1181 has a length L:

L=(2N+1)λ_{g}/4 Eq. (1)

where λ_{g} is the guided wavelength of the RF signal transmitted/received by the first antenna elements 1122-1 inside the dielectric volume 1131, and N is a whole number.

In the illustrated embodiment of FIGS. 11A and 11B, the trace 1181 operates as an open ended transmission line filter placed inside the RF choke 1131 while not perturbing the operation of the RF choke. The trace filter can also be implemented as another type of filter (e.g. short ended transmission line) provided that its length (as set out in Eq. (1)) is modified accordingly. At low band (f1) while the first (bottom) antenna element 1122-1 is operational, signal line 1156 of the second (top) antenna element sees an effective short circuit looking into the trace 1181, such that signal line 1156 is RF shorted to its outer conductor. This RF shorting prevents signal line 1156 from draining power at the low band (f1), where the first (bottom) antenna element 1122-1 operates. As a result, the first (bottom) antenna element 1122-1 has higher radiation efficiency, as compared to a case with no trace filter along signal line 1156.

### Combination Embodiment

FIG. 12A is an isometric of a stack 1200 of the antenna elements 1222-1 and 1222-2 in accordance with one embodiment of the present disclosure. In the illustrated view, the insulating material of the carrier 1233 (e.g., polymer, ceramic, etc.) is not shown for the clarity of the view. The illustrated stack 1200 includes individual antenna elements 1222-1 and 1222-2 and several filtering techniques, including a parasitic patch 1273, a trace filter 1281, and an isolator cavity 1231 (within which the trace filter 1281 is disposed). The illustrated stack also includes a tuning stub 1282 (for top antenna impedance tuning) and capacitive tuning pins 1287 (to tune fc, isolator cavity resonance) and 1285 (to tune bottom antenna resonance and/or create circular polarization for the bottom antenna).

In the illustrated embodiment, the first central conductor 1236 (the coaxial line leading from below the stack is not shown) provides signals to the first antenna patch 1223, and the second central conductor 1256 (the coaxial line leading from below the stack is not shown) provides signals to the second antenna patch 1243. Shielding vias 1257 around the second central conductor 1256 make up the outer conductor surrounding the second central conductor 1256. The total diameter of the circular area occupied by shielding vias 1257 and can be used to tune the frequency of the first (bottom_antenna element 1222-1 and the isolator choke 1240. The shielding vias 1257 that are closest to the central conductor 1256 of the second (top) antenna element 1222-2 can be used to impedance tune the second (top) antenna element 1222-2.

In the illustrated embodiment, the stack 1200 includes a plurality of tuning pins 1285 and 1287, designed, for example, for frequency tuning of the respective antenna elements 1222-1 and the RF choke 1240. The tuning pins can be used to lower the resonance of the cavities they are placed inside. For example pins 1287 can be used to tune the resonance frequency of the isolator cavity, without the need to change the sizing of the isolator cavity as determined by the sizing of the second reflector 1245 and the first antenna patch 1223, hence not perturbing the resonance frequencies of the top and bottom antenna cavities. Same applies to the pins 1285, which can be used to tune the resonance frequency of the bottom antenna cavity, without changing the sizing of 1225 and 1223, hence not perturbing the resonance frequency of the isolator and/or top antenna cavity

In the illustrated embodiment, the stack 1200 includes a trace filter 1281 and a tuning stub 1282, as explained with reference to FIG. 12B below.

FIG. 12B is a bottom view B-B of the stack 1200 shown in FIG. 12A, cut along the middle of the isolator cavity. In some embodiments, the trace filter 1281 may be attached to the second center conductor 1256 for the second antenna element 1222-2 to, for example, filter out the unwanted frequency f1 emitted by the first antenna element 1222-1. In the illustrated embodiment, a tuning stub 1282 is also used to tune the impedance of the trace filter 1281 at high band (f2) to not affect the operation of the second antenna element 1222-2. The trace filter 1281 may be disposed within the isolator cavity 1231 that reduces the power of the RF signal reaching the first antenna element 1222-1 at the unwanted frequency f2 transmitted by the second antenna element 1222-2.

FIG. 12C is a cross-sectional view C-C of the stack 1200 shown in FIG. 12A. In the illustrated embodiment, the second ground reflector 1245 is generally circular, while its corresponding antenna patch 1243 has a non-symmetric shape to create a circularly polarized radiation. Other combinations of shapes are also possible.

While illustrative embodiments have been illustrated and described, it will be appreciated that various changes can be made therein without departing from the spirit and scope of the disclosure.

The embodiments of the present disclosure in which an exclusive property or privilege is claimed are defined as follows:

1. A self-multiplexing antenna, comprising:
a substrate;
a first antenna element carried by the substrate, the first antenna element including a first antenna patch, and a first antenna reflector;
a first signal feed connected with the first antenna patch;
a second antenna element carried by the substrate, wherein the second antenna element is stacked with the first antenna element, the second antenna element including a second antenna patch, and a second antenna reflector;
a second signal feed connected with the second antenna patch; and
a first isolator cavity between the second antenna reflector and the first antenna patch.

2. The self-multiplexing antenna of claim 1, wherein the first antenna element is configured to operate at a first frequency, and the second antenna element is configured to operate at a second frequency different from the first frequency.

3. The self-multiplexing antenna of claim 2, wherein the second frequency is greater than the first frequency.

4. The self-multiplexing antenna of claim 2, wherein a fractional guard-band (edge-to-edge) is selected from the group consisting of greater than 4.5%, greater than 5%, greater, than 6%, and greater than 7%.

5. The self-multiplexing antenna of claim 1, wherein the first signal feed is a center conductor of a first coaxial line, wherein the first coaxial line comprises a first shielding connected to the first antenna reflector, wherein the second signal feed is a center conductor of a second coaxial line, and wherein the second coaxial line comprises a second shielding connected to the second antenna reflector.

6. The self-multiplexing antenna of claim 5, wherein the first shielding and the second shielding include a plurality of metal vias in the substrate.

7. The self-multiplexing antenna of claim 5, wherein the second signal feed is substantially centrally located with respect to the first antenna patch.

8. The self-multiplexing antenna of claim 1, further comprising:
a third antenna element carried by the substrate, wherein the third antenna element is at least partially vertically aligned with the first and second antenna elements, the third antenna element including a third antenna patch, and a third antenna reflector;
a third signal feed connected with the third antenna patch; and
a second isolator cavity between the second antenna patch and the third antenna reflector.

9. The self-multiplexing antenna of claim 1, wherein the substrate is a printed circuit board (PCB) or a ceramic board.

10. The self-multiplexing antenna of claim 2, wherein the first isolator cavity is dimensioned to suppress coupling of RF radiation between the first antenna element and the second antenna element at the second frequency.

11. The self-multiplexing antenna of claim 10, wherein the second antenna element further includes one or more parasitic elements configured to operate at the second frequency.

12. The self-multiplexing antenna of claim 11, wherein the one or more parasitic elements are one or more resonator patches.

13. The self-multiplexing antenna of claim 11, wherein the parasitic elements have the same shape as the second antenna patch.

14. The self-multiplexing antenna of claim 2, further comprising a notch filter connected to the second signal feed of the second antenna and disposed in the first isolator cavity, the notch filter line having a length sized to filter out the first frequency.

15. The self-multiplexing antenna of claim 14, wherein the notch filter is a trace line.

16. The self-multiplexing antenna of claim 15, wherein a first trace line is wound in the first isolator cavity.

17. The self-multiplexing antenna of claim 14, further comprising a tuning stub connected to the notch filter.

18. The self-multiplexing antenna of claim 2, wherein the first isolator cavity is dimensioned to suppress coupling of RF radiation between the first antenna element and the second antenna element at the second frequency.

19. A phased array antenna, comprising:
a carrier; and
a plurality of self-multiplexing antenna element stacks, each stack including a first antenna element configured to transmit and/or receive signals at a first value of a parameter, a second antenna element configured to transmit and/or receive signals at a second value of a parameter, and an isolator cavity between the first and second antenna elements.

20. A self-multiplexing antenna, comprising:
a substrate;
a first antenna element carried by the substrate;
a second antenna element carried by the substrate; and
an isolator cavity disposed between the first antenna element and the second antenna element.
